(19) United States
(12) Patent Application Publication
(10) Pub. No.: US 2024/0311971 A1
(43) Pub. Date: Sep. 19, 2024

(54) SIGNAL PROCESSING METHOD, NON-VOLATILE COMPUTER-READABLE RECORDING MEDIUM, AND SYSTEM

(71) Applicant: Panasonic Intellectual Property Management Co., Ltd., Osaka (JP)

(72) Inventors: MOTOKI YAKO, Osaka (JP); ATSUSHI ISHIKAWA, Osaka (JP)

(21) Appl. No.: 18/673,407

(22) Filed: May 24, 2024

Related U.S. Application Data
(63) Continuation of application No. PCT/JP2022/043656, filed on Nov. 28, 2022.

(30) Foreign Application Priority Data
Dec. 8, 2021 (JP) 2021-199555

(51) Int. Cl. G06T 5/50; G06T 7/00; H04N 23/12

(52) U.S. Cl. CPC G06T 5/50; G06T 7/0002; H04N 23/12; G06T 2200/24; G06T 2207/10036; G06T 2207/20092; G06T 2207/30168

(57) ABSTRACT

A signal processing method executed by a computer includes acquiring designation information for designating N wavelength bands corresponding to N spectral images generated on a basis of a compressed image in which spectral information is compressed, N being an integer greater than or equal to 4; estimating a reconstruction error of each of the N spectral images on the basis of the designation information; and outputting a signal indicative of the reconstruction error.

### BACKGROUND

### 1. Technical Field

The present disclosure relates to a signal processing method, a non-volatile computer-readable recording medium, and a system.

### 2. Description of the Related Art

By using spectral information of a large number of wavelength bands, for example, several tens of bands each having a narrow bandwidth, it is possible to grasp detailed physical properties of a target, which cannot be grasped from a conventional RGB image. A camera that acquires a such multi-wavelength information is called a “hyperspectral camera”. The hyperspectral camera is used in various fields such as food inspection, biological tests, development of medicine, and analysis of components of minerals.

U.S. Pat. No. 9,599,511 (hereinafter referred to as Patent Literature 1) and International Publication No. 2021/145054 (hereinafter referred to as Patent Literature 2) disclose examples of a hyperspectral camera using a compressed sensing technique. In the compressed sensing technique, a compressed image in which spectral information is compressed is acquired by detecting light reflected by a target through a special filter array, and a hyperspectral image having multi-wavelength information is generated on the basis of the compressed image.

### SUMMARY

One non-limiting and exemplary embodiment provides a signal processing method that makes it possible to estimate a reconstruction error of a hyperspectral image.

In one general aspect, the techniques disclosed here feature a signal processing method executed by a computer, including: acquiring designation information for designating N wavelength bands corresponding to N spectral images generated on the basis of a compressed image in which spectral information is compressed, N being an integer greater than or equal to 4; estimating a reconstruction error of each of the N spectral images on the basis of the designation information; and outputting a signal indicative of the reconstruction error.

According to the aspect of the present disclosure, it is possible to estimate a reconstruction error of a hyperspectral image.

It should be noted that general or specific embodiments may be implemented as a device, a system, a method, an integrated circuit, a computer program, a computer-readable storage medium, or any selective combination thereof. Examples of the computer-readable storage medium include non-volatile recording media such as a compact disc-read only memory (CD-ROM).

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A schematically illustrates a configuration of an imaging system according to an exemplary embodiment of the present disclosure;

FIG. 1B schematically illustrates another configuration of the imaging system according to the exemplary embodiment of the present disclosure;

FIG. 1C schematically illustrates still another configuration of the imaging system according to the exemplary embodiment of the present disclosure;

FIG. 1D schematically illustrates still another configuration of the imaging system according to the exemplary embodiment of the present disclosure;

FIG. 2A schematically illustrates an example of a filter array;

FIG. 2B illustrates an example of a spatial distribution of transmittance of light of each of wavelength bands included in a target wavelength range;

FIG. 2C illustrates an example of spectral transmittance of a region included in the filter array illustrated in FIG. 2A;

FIG. 2D illustrates an example of spectral transmittance of a region included in the filter array illustrated in FIG. 2A;

FIG. 3A is a view for explaining a relationship between a target wavelength range and wavelength bands included in the target wavelength range;

FIG. 3B is a view for explaining a relationship between the target wavelength range and the wavelength bands included in the target wavelength range;

FIG. 4A is a view for explaining characteristics of spectral transmittance in a certain region of the filter array;

FIG. 4B illustrates a result of averaging the spectral transmittance illustrated in FIG. 4A for each wavelength band;

FIG. 5A is a graph illustrating transmission spectra of two optical filters included in a certain filter array;

FIG. 5B is a graph illustrating a relationship between randomness of mask data of a certain filter array in a space direction and wavelength resolution;

FIG. 6 is a graph illustrating a transmission spectrum of an optical filter included in a certain filter array;

FIG. 7A is a graph illustrating a correlation coefficient, a spectrum of a correct image, and a spectrum of a reconstruction image;

FIG. 7B is a graph in which relationships between correlation coefficients concerning 99 wavelength bands other than the fiftieth wavelength band and reconstruction errors are plotted from the result illustrated in FIG. 7A;

FIG. 8A is a block diagram schematically illustrating a first example of a system according to the present embodiment;

FIG. 8B is a flowchart schematically illustrating a first example of operation performed by a signal processing circuit in the system illustrated in FIG. 8A;

FIG. 9A is a block diagram schematically illustrating a second example of the system according to the present embodiment;

FIG. 9B is a flowchart schematically illustrating a second example of operation performed by the signal processing circuit in the system illustrated in FIG. 9A;

FIG. 9C is a table illustrating an example of a reconstruction error table;

FIG. 9D is a graph illustrating an example in which a reconstruction error is expressed as a function of wavelength resolution;

FIG. 10A is a block diagram schematically illustrating a third example of the system according to the present embodiment;

FIG. 10B is a block diagram schematically illustrating a fourth example of the system according to the present embodiment;

FIG. 11A is a block diagram schematically illustrating a fifth example of the system according to the present embodiment;

FIG. 11B is a flowchart schematically illustrating an example of operation performed by the signal processing circuit in the system illustrated in FIG. 11A;

FIG. 11C is a flowchart schematically illustrating another example of operation performed by the signal processing circuit in the system illustrated in FIG. 11A;

FIG. 12A illustrates a first example of a display UI displayed in a case where a reconstruction error is larger than a predetermined threshold value;

FIG. 12B illustrates a second example of a display UI displayed in a case where a reconstruction error is larger than a predetermined threshold value;

FIG. 12C illustrates a third example of a display UI displayed in a case where a reconstruction error is larger than a predetermined threshold value;

FIG. 12D illustrates a fourth example of a display UI displayed in a case where a reconstruction error is larger than a predetermined threshold value;

FIG. 13A illustrates a first example of a display UI displayed in a case where some sort of operation is recommended or performed on the basis of an estimated reconstruction error;

FIG. 13B illustrates a second example of a display UI displayed in a case where some sort of operation is recommended or performed on the basis of an estimated reconstruction error;

FIG. 13C illustrates a third example of a display UI displayed in a case where some sort of operation is recommended or performed on the basis of an estimated reconstruction error;

FIG. 13D illustrates a fourth example of a display UI displayed in a case where some sort of operation is recommended or performed on the basis of an estimated reconstruction error;

FIG. 13E illustrates a fifth example of a display UI displayed in a case where some sort of operation is recommended or performed on the basis of an estimated reconstruction error;

FIG. 14 is a view for explaining that a half width of a transmission peak of an optical filter is |λ2−λ1|; and

FIG. 15 is a view for explaining that a half width of a transmission peak of an optical filter is |λ4−λ3|.

### DETAILED DESCRIPTIONS

The embodiment described below illustrates a general or specific example. Numerical values, shapes, materials, constituent elements, positions of the constituent elements, the way in which the constituent elements are connected, steps, and the order of steps in the embodiment below are examples and do not limit the technique of the present disclosure. Among constituent elements in the embodiment below, constituent elements that are not described in independent claims indicating highest concepts are described as optional constituent elements. Each drawing is a schematic view and is not necessarily strict illustration. In each drawing, substantially identical or similar constituent elements are given identical reference signs. Repeated description is sometimes omitted or simplified.

In the present disclosure, all or a part of any of circuit, unit, device, part or portion, or any of functional blocks in the block diagrams may be implemented as one or more of electronic circuits including a semiconductor device, a semiconductor integrated circuit (IC), or a large scale integration (LSI). The LSI or IC can be integrated into one chip, or also can be a combination of chips. For example, functional blocks other than a memory may be integrated into one chip. The name used here is LSI or IC, but it may also be called system LSI, very large scale integration (VLSI), or ultra large scale integration (ULSI) depending on the degree of integration. A Field Programmable Gate Array (FPGA) that can be programmed after manufacturing an LSI or a reconfigurable logic device that allows reconfiguration of the connection or setup of circuit cells inside the LSI can be used for the same purpose.

Further, it is also possible that all or a part of the functions or operations of the circuit, unit, device, part or portion are implemented by executing software. In such a case, the software is recorded on one or more non-transitory recording media such as a ROM, an optical disk or a hard disk drive, and when the software is executed by a processor, the software causes the processor together with peripheral devices to execute the functions specified in the software. A system or apparatus may include such one or more non-transitory recording media on which the software is recorded and a processor together with necessary hardware devices such as an interface.

### Explanation of Terms in Present Specification

Before describing the embodiment of the present disclosure, terms used in the present specification are described. An imaging device according to the present embodiment acquires a compressed image in which spectral information is compressed by imaging light reflected by a target through a filter array including optical filters arranged within a two-dimensional plane. The imaging device according to the present embodiment further generates a spectral image concerning each of N wavelength bands (N is an integer greater than or equal to 4) within a target wavelength range from the compressed image by computation based on mask data of the filter array. As a result, a hyperspectral image of the target can be generated.

### Target Wavelength Range

The target wavelength range is a wavelength range determined on the basis of an upper limit and a lower limit of a wavelength of light incident on an image sensor used for imaging. The target wavelength range can be, for example, any range within a range from an upper limit to a lower limit of a wavelength where the image sensor has sensitivity, that is, a sensitivity wavelength range. In a case where a target that absorbs and/or reflects light in the sensitivity wavelength range is disposed on an optical axis of the image sensor, the target wavelength range may be a part of the sensitivity wavelength range of the image sensor. The target wavelength range may correspond to a wavelength range of data output from the image sensor, that is, an output wavelength range.

### Wavelength Resolution

A wavelength resolution is a width of a wavelength band for each of which a spectral image is generated by reconstruction. For example, in a case where a spectral image corresponding to a wavelength range having a width of 5 nm is generated, the wavelength resolution is 5 nm. Similarly, in a case where a spectral image corresponding to a wavelength range having a width of 20 nm is generated, the wavelength resolution is 20 nm.

### Mask Data

Mask data is data indicating arrangement based on a spatial distribution of transmittance of the filter array. Data indicating a spatial distribution of transmittance of the filter array itself may be used as the mask data or data obtained by performing reversible calculation on the transmittance of the filter array may be used as the mask data. The reversible calculation is, for example, addition, subtraction, multiplication and division of a certain value, exponentiation, index calculation, logarithm calculation, and gamma correction. The reversible calculation may be uniformly performed within the target wavelength range or may be performed for each wavelength band, which will be described later.

In a case where data indicating a spatial distribution of transmittance of the filter array itself is used as the mask data, an intensity of light that passes the filter array in a wavelength range having a finite width within the target wavelength range is observed as a matrix in which data is arranged two-dimensionally. The target wavelength range can be, for example, greater than or equal to 400 nm and less than or equal to 700 nm, and the wavelength range having a finite width can be, for example, greater than or equal to 400 nm and less than or equal to 450 nm. By performing the observation so that the entire target wavelength range is covered, matrices are generated. Each of the matrices is data arranged two-dimensionally in a space direction. The data arranged two-dimensionally in a space direction acquired in wavelength ranges is collectively referred to as mask data.

The wavelength range greater than or equal to 400 nm and less than or equal to 450 nm is the “wavelength range having a finite width” in the above example, and wavelengths are not distinguished within this wavelength range in calculation. That is, only intensity information is recorded and used for calculation, and therefore only an intensity is recorded and no wavelength information is stored both in a case where light of 420 nm is incident and a case where light of 430 nm is incident. Accordingly, all wavelengths within this wavelength range are handled as an identical wavelength in calculation.

A spatial distribution of transmittance of the filter array can be, for example, observed by using a light source that outputs only a specific wavelength and an integrating sphere. In the above example, only light of a wavelength greater than or equal to 400 nm and less than or equal to 450 nm is output from a light source, and the output light is detected through the filter array after being diffused uniformly by the integrating sphere. As a result, an image in which, for example, sensitivity of the image sensor and/or aberration of a lens is superimposed on a spatial distribution of transmittance of the filter array in the wavelength range greater than or equal to 400 nm and less than or equal to 450 nm is obtained. The obtained image can be handled as a matrix. In a case where the sensitivity of the image sensor and/or the aberration of the lens are known, the spatial distribution of the transmittance of the filter array can be obtained by correcting the obtained image. It can be interpreted that the obtained image is an image obtained by performing reversible calculation such as the sensitivity of the image sensor and/or the aberration of the lens on the spatial distribution of the transmittance of the filter array. Therefore, the obtained image need not necessarily be corrected.

Actually, transmittance cannot be non-continuously changed before and after a certain wavelength and fluctuates with a finite rising angle or falling angle. Therefore, an upper limit and a lower limit of a wavelength range can be defined by a wavelength at which transmittance has attenuated from a peak intensity by a certain percentage. The certain percentage can be, for example, 90%, 50%, or 10% of the peak intensity.

In a case where mask data is, for example, stored in a memory, the mask data can be compressed in a reversible format such as Portable Network Graphics (PNG) or Graphics Interchange Format (GIF).

### Wavelength Band

The wavelength band is a wavelength range within the target wavelength range and is a range of wavelengths handled as an identical wavelength in mask data. The wavelength band can be a wavelength range having a certain width as is indicated by “band”. The wavelength band can be, for example, a wavelength range having a width of 50 nm that is greater than or equal to 500 nm and less than or equal to 550 nm. In the present specification, a group of wavelength ranges having a certain width is also referred to as a “wavelength band”. The wavelength band can be a wavelength range having a width of 100 nm obtained by summing up a wavelength range having a width 50 nm that is greater than or equal to 500 nm and less than or equal to 550 nm and a wavelength range having a width 50 nm that is greater than or equal to 600 nm and less than or equal to 650 nm. Since a wavelength band may be handled as an identical wavelength in mask data, whether wavelength ranges are continuous need not be considered.

### Spectral Image

The spectral image is a two-dimensional image output for each wavelength band as a result of reconstruction computation. Since the spectral image is generated for each wavelength band, one spectral image is decided corresponding to a certain wavelength band. The spectral image may be output as a monochromatic image. Spectral images corresponding to wavelength bands may be output as data three-dimensionally arranged in a space direction and a wavelength direction. Alternatively, the spectral images may be output as data in which pixel values are arranged one-dimensionally. Each of the pixel values corresponds to a combination of a wavelength band and a pixel. Alternatively, spectral images given header information including meta-information such as space resolution and the number of wavelength bands may be output. In the present specification, the spectral image is also referred to as a reconstructed image.

### Reconstruction Accuracy

Reconstruction accuracy is a degree of deviation between a generated spectral image and a correct image. The reconstruction accuracy can be expressed by using various indices such as a Mean Squared Error (MSE) and a Peak Signal-to-Noise Ratio (PSNR). Actually, it is often not easy to define the correct image. In this case, the correct image may be defined and actual reconstruction accuracy may be estimated or defined by the following method. The method is, for example, to examine wavelength dependency of the correct image by using a band-pass filter that allows only light having a specific wavelength to pass, a target whose transmission and/or reflection spectra are known, and a laser whose light emission wavelength is known.

### Underlying Knowledge Forming Basis of the Present Disclosure

Next, before description of the embodiment of the present disclosure, image reconstruction processing based on sparsity and a method for evaluating randomness of mask data are described in relation to the problem to be solved by the present disclosure.

Sparsity is such a property that an element that characterizes a target is present sparsely in a certain direction such as a space direction or a wavelength direction. Sparsity is widely observed in nature. By utilizing sparsity, necessary information can be efficiently acquired. A sensing technique utilizing sparsity is called a compressed sensing technique. It has been revealed that the compressed sensing technique makes it possible to efficiently construct a device or a system. As disclosed in Patent Literature 1, application of the compressed sensing technique to a hyperspectral camera allows improvement in wavelength resolution, high-resolution, multiple-wavelength, and imaging of a multiple-wavelength moving image.

An example of application of the compressed sensing technique to a hyperspectral camera is as follows. A filter array through which light reflected by a target passes and an image sensor that detects light that passes through the filter array are disposed on an optical path of the reflected light. The filter array has random transmission characteristics in a space direction and/or a wavelength direction. The light reflected by the target passes through the filter array, and as a result, the target can be imaged in such a manner that information on the target is coded. By generating a spectral image from the compressed image thus taken on the basis of mask data of the filter array, hyperspectral image reconstruction processing can be performed. The reconstruction processing is performed by estimation computation assuming sparsity of a target, that is, sparse reconstruction. Computation performed in sparse reconstruction can be, for example, computation of estimating a spectral image by minimization of an evaluation function including a regularization term, as disclosed in Patent Literature 1. The regularization term can be, for example, discrete cosine transform (DCT), wavelet transform, Fourier transform, or total variation (TV).

In reconstruction of a hyperspectral image based on sparse reconstruction, it is assumed that information on a target is randomly sampled. Randomness of transmittance of a filter array in a space direction and a wavelength direction influences reconstruction accuracy of a hyperspectral image. In a case where a filter that is not random in the space direction is used, a spatial information amount is insufficient, and a hyperspectral image in which space information is missing is generated. In a case where a filter that is not random in the wavelength direction is used, wavelength information is insufficient, and wavelength resolution decreases in reconstruction of a hyperspectral image. As for randomness in a space direction, an evaluation method based on a standard deviation of an average μ1 of transmittances corresponding to filters included in a filter array concerning light of a first wavelength band to an average μN of transmittances corresponding to the filters included in the filter array concerning light of an N-th wavelength band is disclosed (Patent Literature 2). As for randomness in a wavelength direction, an evaluation method based on a correlation coefficient concerning two wavelength bands is disclosed (Japanese Patent No. 6478579).

The inventors of the present invention found that a reconstruction error of a hyperspectral image can be estimated by determining wavelength resolution since randomness of mask data of a filter array in a space direction and a wavelength direction changes depending on the wavelength resolution, as described later. A signal processing method according to an embodiment of the present disclosure estimates a reconstruction error of a hyperspectral image on the basis of wavelength resolution. The following describes a signal processing method, a non-volatile computer-readable recording medium, and a system according to the embodiment of the present disclosure.

A method according to a first item is a signal processing method executed by a computer. The method includes acquiring designation information for designating N wavelength bands corresponding to N spectral images generated on the basis of a compressed image in which spectral information is compressed, N being an integer greater than or equal to 4; estimating a reconstruction error of each of the N spectral images on the basis of the designation information; and outputting a signal indicative of the reconstruction error.

According to this method, it is possible to estimate a reconstruction error of a hyperspectral image.

In the method according to the first item, a method according to a second item is arranged such that the compressed image is generated by imaging using a filter array including kinds of optical filters that are different in spectral transmittance and an image sensor. The method further includes acquiring mask data reflecting spatial distributions of the spectral transmittance of the filter array concerning the N wavelength bands. The estimating the reconstruction error includes estimating the reconstruction error on the basis of the designation information and the mask data.

According to this method, a reconstruction error of a hyperspectral image can be estimated on the basis of the designation information and the mask data.

In the method according to the second item, a method according to a third item is arranged such that the N wavelength bands include an i-th wavelength band and a j-th wavelength band. The estimating the reconstruction error includes: extracting, from the mask data, i-th mask data reflecting a spatial distribution of transmittance of the filter array corresponding to the i-th wavelength band and j-th mask data reflecting a spatial distribution of transmittance of the filter array corresponding to the j-th wavelength band among the N wavelength bands on the basis of the designation information, and estimating the reconstruction error on the basis of a correlation coefficient between the i-th mask data and the j-th mask data.

According to this method, a reconstruction error can be estimated on the basis of the correlation coefficient of the mask data.

In the method according to the second or third item, a method according to a fourth item further includes displaying a GUI for allowing a user to input the designation information on a display connected to the computer.

According to this method, a user can input the designation information through the GUI.

In the method according to the fourth item, a method according to a fifth item further includes displaying a warning on the display in a case where the reconstruction error is larger than a predetermined threshold value.

According to this method, user's attention can be attracted in a case where the reconstruction error is larger than the predetermined threshold value.

In the method according to the fifth item, a method according to a sixth item further includes displaying a GUI for allowing the user to input the designation information again on the display.

According to this method, the user can input the designation information again in a case where the reconstruction error is larger than the predetermined threshold value.

In the method according to the fifth item, a method according to a seventh item further includes changing the N wavelength bands on the basis of the mask data so that the reconstruction error becomes equal to or smaller than the predetermined threshold value; and displaying the changed N wavelength bands on the display.

According to this method, the user can know the changed N wavelength bands.

In the method according to the fourth item, a method according to an eighth item further includes generating the N spectral images on the basis of the compressed image; displaying the N spectral images on the display; and displaying at least one spectral image having a reconstruction error larger than a predetermined threshold value among the N spectral images in an emphasized manner.

According to this method, the user can know at least one spectral image having a reconstruction error larger than the predetermined threshold value.

In the method according to any one of the fourth to eighth items, a method according to a ninth item further includes displaying the reconstruction error on the display.

According to this method, the user can know the reconstruction error.

In the method according to any one of the first to ninth items, a method according to a tenth item is arranged such that the N wavelength bands include two adjacent wavelength bands that are not continuous.

According to this method, a reconstruction error of a hyperspectral image can be estimated even in a case where the N wavelength bands include two adjacent wavelength bands that are not continuous.

In the method according to the first item, a method according to an eleventh item further includes acquiring data indicative of a relationship between the wavelength bands and the reconstruction error. The estimating the reconstruction error includes estimating the reconstruction error of each of the N spectral images on the basis of the data.

According to this method, a reconstruction error of a hyperspectral image can be estimated on the basis of data indicative of a relationship between the wavelength bands and the reconstruction error.

A non-volatile computer-readable recording medium according to a twelfth item is a non-volatile computer-readable recording medium storing a program causing a computer to perform processing. The processing includes acquiring designation information for designating N wavelength bands corresponding to N spectral images generated on the basis of a compressed image in which spectral information is compressed, N being an integer greater than or equal to 4; estimating a reconstruction error of each of the N spectral images on the basis of the designation information; and outputting a signal indicative of the reconstruction error.

According to this non-volatile computer-readable recording medium, it is possible to estimate a reconstruction error of a hyperspectral image.

A system according to a thirteenth item is a system including a signal processing circuit. The signal processing circuit acquires designation information for designating N wavelength bands corresponding to N spectral images generated on the basis of a compressed image in which spectral information is compressed, N being an integer greater than or equal to 4, estimates a reconstruction error of each of the N spectral images on the basis of the designation information, and outputs a signal indicative of the reconstruction error.

According to this system, it is possible to estimate a reconstruction error of a hyperspectral image. A more specific embodiment of the present disclosure is described below with reference to the drawings.

### Embodiment

### Imaging System

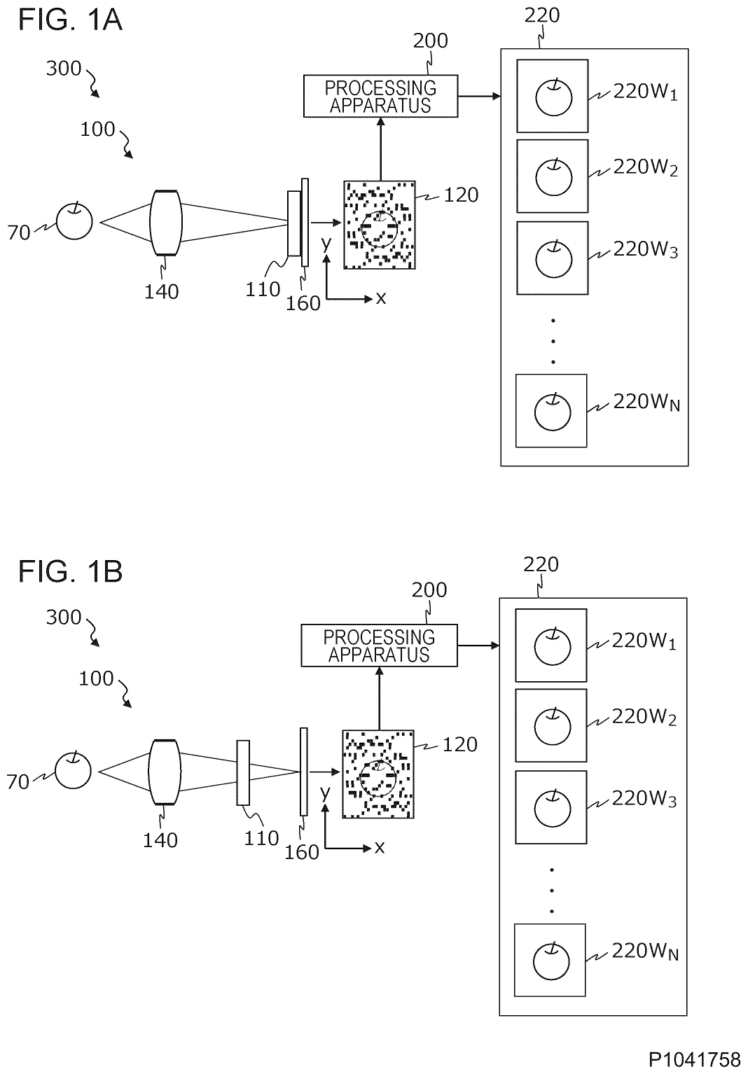

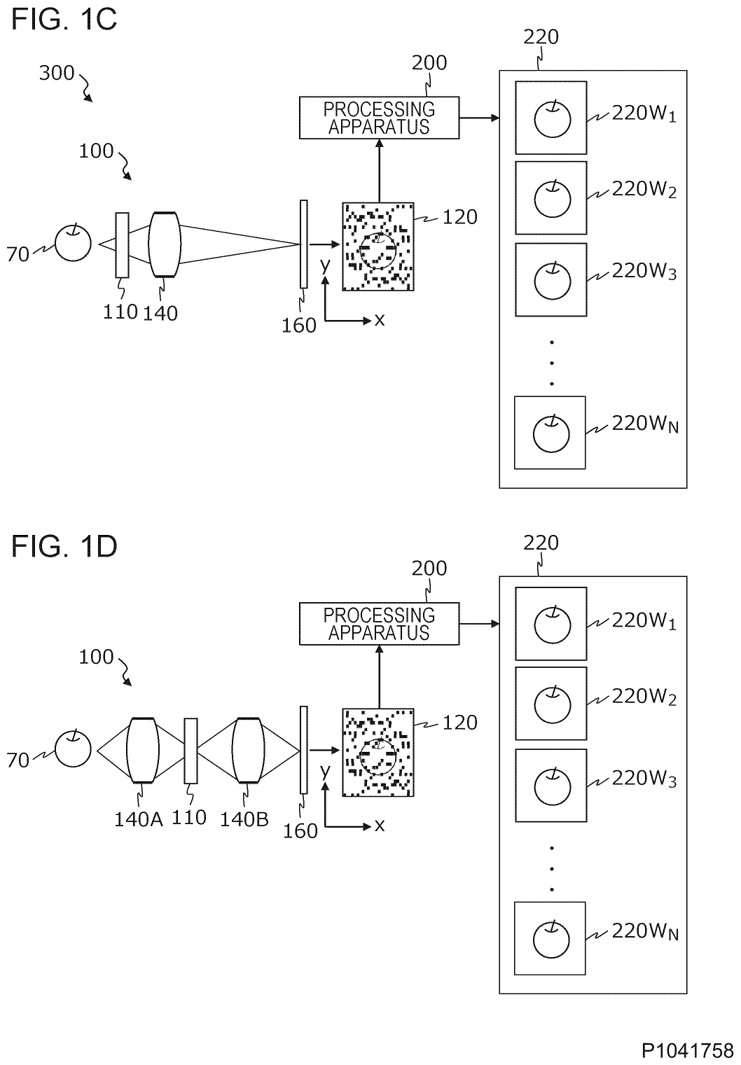

First, an example of a configuration of an imaging system used in the embodiment of the present disclosure is described with reference to FIGS. 1A to 1D.

FIG. 1A schematically illustrates a configuration of an imaging system according to an exemplary embodiment of the present disclosure. The imaging system illustrated in FIG. 1A includes an imaging device 100 and a processing apparatus 200. The imaging device 100 includes a similar configuration to the imaging device disclosed in Patent Literature 1. The imaging device 100 includes an optical system 140, a filter array 110, and an image sensor 160. The optical system 140 and the filter array 110 are disposed on an optical path of light reflected by a target 70, which is a subject. The filter array 110 is disposed between the optical system 140 and the image sensor 160.

In FIG. 1A, an apple is illustrated as an example of the target 70. The target 70 is not limited to an apple and can be any object that can be an inspection target. The image sensor 160 generates data of a compressed image 120 that is information on wavelength bands compressed as a two-dimensional monochromatic image. The processing apparatus 200 can generate image data for each of wavelength bands included in a target wavelength range on the basis of the data of the compressed image 120 generated by the image sensor 160. The generated pieces of image data that correspond to the wavelength bands on a one-to-one basis are hereinafter referred to as “hyperspectral image data”. It is assumed here that the number of wavelength bands included in the target wavelength range is N (N is an integer greater than or equal to 4). In the following description, the generated pieces of image data that correspond to the wavelength bands on a one-to-one basis are referred to as a spectral image 220W₁, a spectral image 220W₂, . . . , and a spectral image 220W_{N}, which are collectively referred to as a “hyperspectral image 220”. Hereinafter, signals indicative of an image, that is, a collection of signals indicative of pixel values of pixels is sometimes referred to simply as an “image”.

The filter array 110 includes light-transmitting optical filters that are arranged in rows and columns. The optical filters include kinds of optical filters that are different from each other in spectral transmittance, that is, wavelength dependence of transmittance. The filter array 110 outputs incident light after modulating an intensity of the incident light for each wavelength. This process performed by the filter array 110 is hereinafter referred to as “coding”.

In the example illustrated in FIG. 1A, the filter array 110 is disposed in the vicinity of or directly above the image sensor 160. The “vicinity” as used herein means being close to such a degree that an image of light from the optical system 140 is formed on a surface of the filter array 110 in a certain level of clarity. The “directly above” means that the filter array 110 and the image sensor 160 are disposed close to such a degree that almost no gap is formed therebetween. The filter array 110 and the image sensor 160 may be integral with each other.

The optical system 140 includes at least one lens. Although the optical system 140 is illustrated as a single lens in FIG. 1A, the optical system 140 may be a combination of lenses. The optical system 140 forms an image on an imaging surface of the image sensor 160 through the filter array 110.

The image sensor 160 is a monochromatic photodetector that has photodetection elements (hereinafter also referred to as “pixels”) that are arranged two-dimensionally. The image sensor 160 can be, for example, a charge-coupled device (CCD), a complementary metal oxide semiconductor (CMOS) sensor, or an infrared array sensor. Each of the photodetection elements includes, for example, a photodiode. The image sensor 160 need not necessarily be a monochromatic sensor. For example, it is also possible to use a color-type sensor including R/G/B optical filters (an optical filter that allows red light to pass therethrough, an optical filter that allows green light to pass therethrough, and an optical filter that allows blue light to pass therethrough), R/G/B/IR optical filters (an optical filter that allows red light to pass therethrough, an optical filter that allows green light to pass therethrough, an optical filter that allows blue light to pass therethrough, and an optical filter that allows an infrared ray to pass therethrough), or R/G/B/W optical filters (an optical filter that allows red light to pass therethrough, an optical filter that allows green light to pass therethrough, an optical filter that allows blue light to pass therethrough, and an optical filter that allows white light to pass therethrough). Use of a color-type sensor can increase an amount of information concerning a wavelength and can improve accuracy of reconstruction of the hyperspectral image 220. The target wavelength range may be any wavelength range, and is not limited to a visible wavelength range and may be a wavelength range such as an ultraviolet wavelength range, a near-infrared wavelength range, a mid-infrared wavelength range, or a far-infrared wavelength range.

The processing apparatus 200 is a computer including a processor and a storage medium such as a memory. The processing apparatus 200 generates data of the spectral image 220W₁ corresponding to the wavelength band W₁, the spectral image 220W₂ corresponding to the wavelength band W₂, . . . , and the spectral image 220W_{N} corresponding to the wavelength band W_{N} on the basis of the compressed image 120 acquired by the image sensor 160.

FIGS. 1B to 1D schematically illustrate another configuration of the imaging system according to the exemplary embodiment of the present disclosure. In the imaging system illustrated in FIGS. 1B to 1D, the filter array 110 is disposed away from the image sensor 160 in the imaging device 100. In the example illustrated in FIG. 1B, the filter array 110 is disposed away from the image sensor 160 between the optical system 140 and the image sensor 160. In the example illustrated in FIG. 1C, the filter array 110 is disposed between the target 70 and the optical system 140. In the example illustrated in FIG. 1D, the imaging device 100 includes optical systems 140A and 140B, and the filter array 110 is disposed between the optical systems 140A and 140B. As in these examples, an optical system including one or more lenses may be disposed between the filter array 110 and the image sensor 160.

### Characteristics of Filter Array

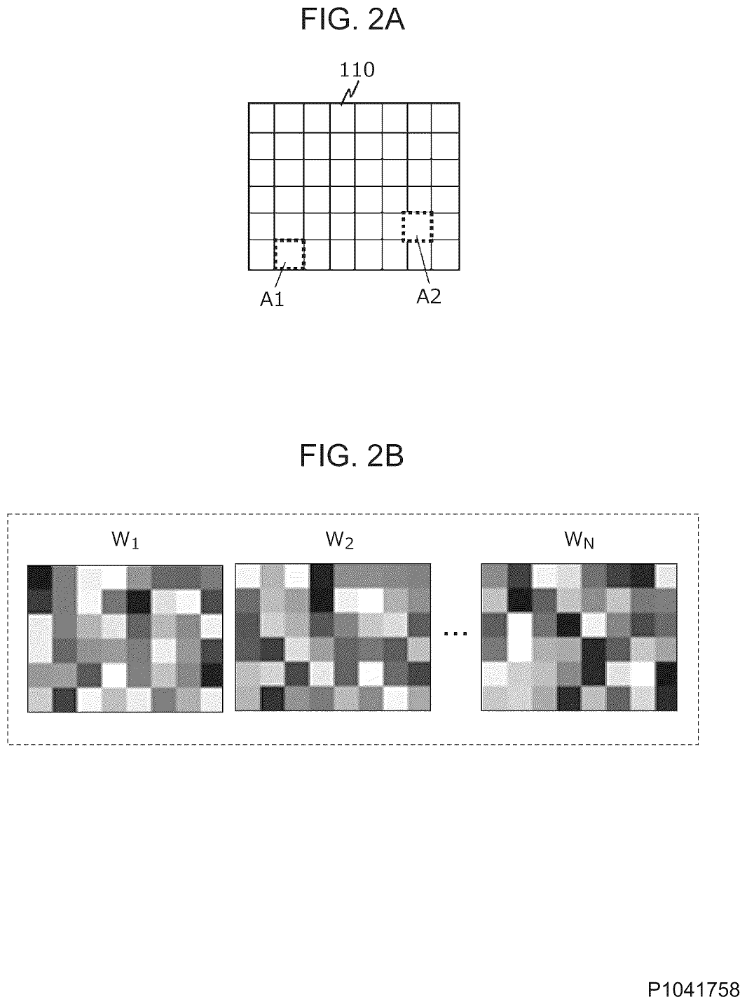

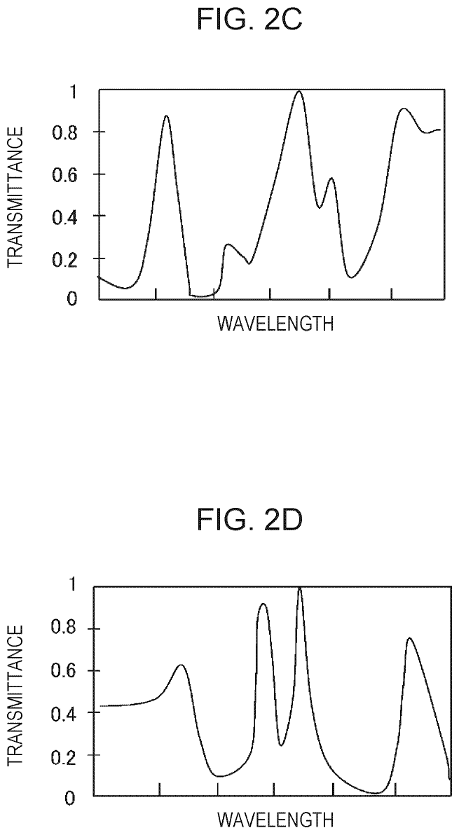

Next, characteristics of the filter array 110 are described with reference to FIGS. 2A to 4B. FIG. 2A schematically illustrates an example of the filter array 110. The filter array 110 includes regions arranged within a two-dimensional plane. Hereinafter, each of the regions is sometimes referred to as a “cell”. In each of the regions, an optical filter having individually set spectral transmittance is disposed. The spectral transmittance is expressed as a function T (λ) where λ is a wavelength of incident light. The spectral transmittance T (λ) can take a value greater than or equal to 0 and less than or equal to 1.

In the example illustrated in FIG. 2A, the filter array 110 has 48 rectangular regions arranged in 6 rows and 8 columns. This is merely an example, and a larger number of regions can be provided in actual use. For example, the number of regions may be similar to the number of pixels of the image sensor 160. The number of optical filters included in the filter array 110 is, for example, decided within a range from tens of optical filters to tens of millions of optical filters.

FIG. 2B illustrates an example of a spatial distribution of transmittance of light of each of the wavelength bands W₁, W₂, . . . , and W_{N} included in the target wavelength range. In the example illustrated in FIG. 2B, differences in density among regions represent differences in transmittance. A paler region has higher transmittance, and a deeper region has lower transmittance. As illustrated in FIG. 2B, a spatial distribution of light transmittance varies depending on a wavelength band. Data indicative of a spatial distribution of transmittance of the filter array 110 for each of the wavelength bands included in the target wavelength range is mask data of the filter array 110.

FIGS. 2C and 2D illustrate an example of spectral transmittance of a region A1 and an example of spectral transmittance of a region A2 included in the filter array 110 illustrated in FIG. 2A, respectively. The spectral transmittance of the region A1 and the spectral transmittance of the region A2 are different from each other. That is, the spectral transmittance of one region included in the filter array 110 varies from another region included in the filter array 110. However, not all regions need to be different in spectral transmittance. In the filter array 110, at least some of the regions are different from each other in spectral transmittance. The filter array 110 includes two or more filters that are different from each other in spectral transmittance. That is, the filter array 110 includes kinds of optical filters that are different in transmission spectrum. In one example, the number of patterns of spectral transmittance of the regions included in the filter array 110 can be identical to or larger than the number N of wavelength bands included in the target wavelength range. The filter array 110 may be designed so that half or more of the regions is different in spectral transmittance. In another example, the filter array 110 includes 10⁶ to 10⁷ optical filters, and the optical filters may include four or more kinds of optical filters that are arranged irregularly.

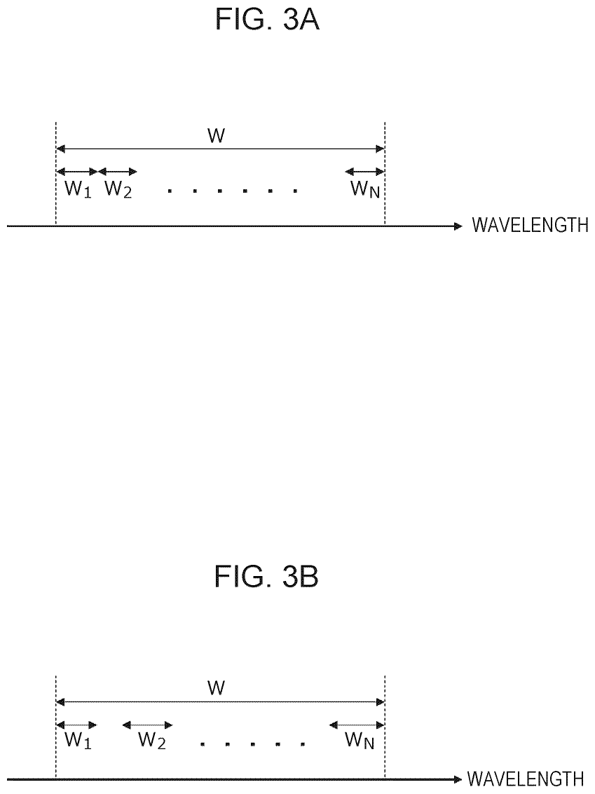

FIGS. 3A and 3B are views for explaining a relationship between the target wavelength range W and the wavelength bands W₁, W₂, . . . , and W_{N} included in the target wavelength range W. The target wavelength range W can be set to various ranges depending on use. The target wavelength range W can be, for example, a wavelength range of visible light greater than or equal to approximately 400 nm and less than or equal to approximately 700 nm, a wavelength range of a near-infrared ray greater than or equal to approximately 700 nm and less than or equal to approximately 2500 nm, or a wavelength range of a near-ultraviolet ray greater than or equal to approximately 10 nm and less than or equal to approximately 400 nm. Alternatively, the target wavelength range W may be a wavelength range such as a mid-infrared wavelength range or a far-infrared wavelength range. That is, a wavelength range used is not limited to a visible light region.

Hereinafter, “light” means electromagnetic waves including not only visible light (having a wavelength greater than or equal to approximately 400 nm and less than or equal to approximately 700 nm), but also an ultraviolet ray (having a wavelength greater than or equal to approximately 10 nm and less than or equal to approximately 400 nm) and an infrared ray (having a wavelength greater than or equal to approximately 700 nm and less than or equal to approximately 1 mm)

In the example illustrated in FIG. 3A, N wavelength ranges obtained by equally dividing the target wavelength range W are the wavelength band W₁, the wavelength band W₂, . . . , and the wavelength band W_{N} where N is an integer greater than or equal to 4. However, such an example is not restrictive. The wavelength bands included in the target wavelength range W may be set in any ways. For example, the wavelength bands may have non-uniform bandwidths. A gap may be present between adjacent wavelength bands or adjacent wavelength bands may overlap each other. In the example illustrated in FIG. 3B, a bandwidth varies from one wavelength band to another and a gap is present between adjacent two wavelength bands. In this way, the wavelength bands can be decided in any way as long as the wavelength bands are different from one another.

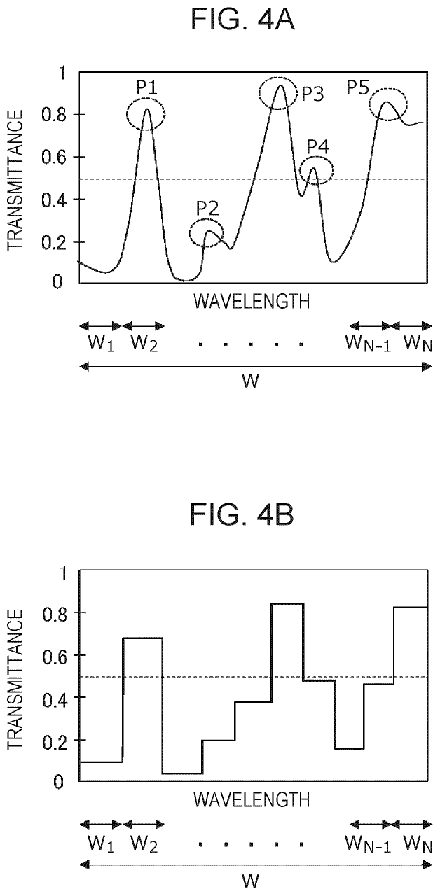

FIG. 4A is a view for explaining characteristics of spectral transmittance in a region of the filter array 110. In the example illustrated in FIG. 4A, the spectral transmittance has local maximum values (i.e., local maximum values P1 to P5) and minimum values concerning wavelengths within the target wavelength range W. In the example illustrated in FIG. 4A, normalization is performed so that a maximum value of light transmittance within the target wavelength range W is 1 and a minimum value of light transmittance within the target wavelength range W is 0. In the example illustrated in FIG. 4A, the spectral transmittance has a local maximum value in each of the wavelength ranges such as the wavelength band W₂ and a wavelength band W_{N-1}. In this way, spectral transmittance of each region can be designed in such a manner that at least two wavelength ranges among the wavelength bands W₁ to W_{N} each have a local maximum value. In the example of FIG. 4A, the local maximum value P1, the local maximum value P3, the local maximum value P4, and the maximum value P5 are 0.5 or more.

As described above, light transmittance of each region varies depending on a wavelength. Therefore, the filter array 110 allows a component of a certain wavelength range of incident light to pass therethrough much and hardly allows a component of another wavelength range to pass therethrough. For example, transmittance of light of k wavelength bands among the N wavelength bands can be larger than 0.5, and transmittance of light of remaining N−k wavelength ranges can be less than 0.5. k is an integer that satisfies 2≤k<N. If incident light is white light equally including all visible light wavelength components, the filter array 110 modulates, for each region, the incident light into light having discrete intensity peaks concerning wavelengths and superimposes and outputs the light of multiple wavelengths.

FIG. 4B illustrates, for example, a result of averaging the spectral transmittance illustrated in FIG. 4A for each of the wavelength band W₁, the wavelength band W₂, . . . , and the wavelength band W_{N}. The averaged transmittance is obtained by integrating the spectral transmittance T (λ) for each wavelength band and dividing the integrated spectral transmittance T (λ) by a bandwidth of the wavelength band. Hereinafter, a value of the averaged transmittance for each wavelength band is used as transmittance in the wavelength band. In this example, transmittance is markedly high in a wavelength range that takes the local maximum value P1, a wavelength range that takes the local maximum value P3, and a wavelength range that takes the local maximum value P5. In particular, transmittance is higher than 0.8 in the wavelength range that takes the local maximum value P3 and the wavelength range that takes the local maximum value P5.

In the example illustrated in FIGS. 2A to 2D, a gray-scale transmittance distribution in which transmittance of each region can take any value greater than or equal to 0 and less than or equal to 1 is assumed. However, the transmittance distribution need not necessarily be a gray-scale transmittance distribution. For example, a binary-scale transmittance distribution in which transmittance of each region can take either almost 0 or almost 1 may be employed. In the binary-scale transmittance distribution, each region allows transmission of a large part of light of at least two wavelength ranges among wavelength ranges included in the target wavelength range and does not allow transmission of a large part of light of a remaining wavelength range. The “large part” refers to approximately 80% or more.

A certain cell among all cells, for example, a half of all the cells may be replaced with a transparent region. Such a transparent region allows transmission of light of all of the wavelength bands W₁ to W_{N} included in the target wavelength range W at equally high transmittance, for example, transmittance of 80% or more. In such a configuration, transparent regions can be, for example, disposed in a checkerboard pattern. That is, a region in which light transmittance varies depending on a wavelength and a transparent region can be alternately arranged in two alignment directions of the regions of the filter array 110.

Data indicative of such a spatial distribution of spectral transmittance of the filter array 110 is acquired in advance on the basis of design data or actual calibration and is stored in a storage medium included in the processing apparatus 200. This data is used for arithmetic processing which will be described later.

The filter array 110 can be, for example, constituted by a multi-layer film, an organic material, a diffraction grating structure, or a microstructure containing a metal. In a case where a multi-layer film is used, for example, a dielectric multi-layer film or a multi-layer film including a metal layer can be used. In this case, the filter array 110 is formed so that at least one of a thickness, a material, and a laminating order of each multi-layer film varies from one cell to another. This can realize spectral characteristics that vary from one cell to another. Use of a multi-layer film can realize sharp rising and falling in spectral transmittance. A configuration using an organic material can be realized by varying contained pigment or dye from one cell to another or laminating different kinds of materials. A configuration using a diffraction grating structure can be realized by providing a diffraction structure having a diffraction pitch or depth that varies from one cell to another. In a case where a microstructure containing a metal is used, the filter array 110 can be produced by utilizing dispersion of light based on a plasmon effect. Reconstruction of Hyperspectral Image

Next, an example of signal processing performed by the processing apparatus 200 is described. The processing apparatus 200 generates the multiple-wavelength hyperspectral image 220 on the basis of the compressed image 10 output from the image sensor 160 and spatial distribution characteristics of transmittance for each wavelength of the filter array 110. The “multiple-wavelength” means, for example, a larger number of wavelength ranges than wavelength ranges of three colors of R, G, and B acquired by a general color camera. The number of wavelength ranges can be, for example, 4 to approximately 100. The number of wavelength ranges is referred to as “the number of bands”. The number of bands may be larger than 100 depending on intended use.

Data to be obtained is data of the hyperspectral image 220, which is expressed as f. The data f is data unifying image data f₁ corresponding to the wavelength band W₁, image data f₂ corresponding to the wavelength band W₂, . . . , and image data f_{N} corresponding to the wavelength band W_{N} where N is the number of bands. It is assumed here that a lateral direction of the image is an x direction and a longitudinal direction of the image is a y direction, as illustrated in FIG. 1A. Each of the image data f₁, f₂, . . . , and f_{N} is two-dimensional data including v×u pixel values corresponding to v×u pixels where v is the number of pixels of the image data to be obtained in the x direction and u is the number of pixels of the image data to be obtained in the y direction. Accordingly, the data f is three-dimensional data that has v×u×N elements. This three-dimensional data is referred to as “hyperspectral image data” or a “hyperspectral data cube”. Meanwhile, data g of the compressed image 120 acquired by coding and multiplexing by the filter array 110 is two-dimensional data including v×u pixel values corresponding to v×u pixels. The data g can be expressed by the following formula (1).

$$g = H f = H [ \begin{matrix}{f}_{1} \\ {f}_{2} \\ ⋮ \\ {f}_{N}\end{matrix} ] g \qquad ( 1 )$$

included in the formulas (1) and (2) is sometimes expressed as g in descriptions related to the formulas (1) and (2).

In the formula (1), each of f₁, f₂, . . . , and f_{N} is expressed as a one-dimensional vector of v×u rows and 1 column. Accordingly, a vector of the right side is a one-dimensional vector of v×u×N rows and 1 column. In the formula (1), the data g of the compressed image 120 is expressed as a one-dimensional vector of v×u rows and 1 column. A matrix H represents conversion of performing coding and intensity modulation of components f₁, f₂, . . . , and f_{N} of the vector f by using different pieces of coding information for the respective wavelength bands and adding results thus obtained. Accordingly, H is a matrix of v×u rows and v×u×N columns.

It seems that when the vector g and the matrix H are given, f can be calculated by solving an inverse problem of the formula (1). However, since the number of elements v×u×N of the data f to be obtained is larger than the number of elements v×u of the acquired data g, this problem is an ill-posed problem and cannot be solved. In view of this, the processing apparatus 200 finds a solution by using a method of compressed sensing while utilizing redundancy of the images included in the data f. Specifically, the data f to be obtained is estimated by solving the following formula (2).

$${f}^{′} = {argmin}_{f} \{ {‖ g - Hf ‖}_{{l}_{2}} + τ Φ ( f ) \} \qquad ( 2 )$$

In the formula (2), f represents the estimated data f. The first term in the parentheses in the above formula represents a difference amount between an estimation result Hf and the acquired data g, that is, a residual term. Although a sum of squares is a residual term in this formula, an absolute value, a square-root of sum of squares, or the like may be a residual term. The second term in the parentheses is a regularization term or a stabilization term. The formula (2) means that f that minimizes a sum of the first term and the second term is found. The processing apparatus 200 can calculate the final solution f by convergence of solutions by recursive iterative operation.

The first term in the parentheses in the formula (2) means operation of finding a sum of squares of a difference between the acquired data g and Hf obtained by converting f in the estimation process by the matrix H. ϕ(f) in the second term is a constraint condition in regularization of f and is a function reflecting sparse information of the estimated data. This function brings an effect of smoothing or stabilizing the estimated data. The regularization term can be, for example, expressed by discrete cosine transform (DCT), wavelet transform, Fourier transform, total variation (TV), or the like of f. For example, in a case where total variation is used, stable estimated data with suppressed influence of noise of the observed data g can be acquired. Sparsity of the target 70 in a space direction of the regularization term varies depending on texture of the target 70. A regularization term that makes the texture of the target 70 more sparse in the space direction of the regularization term may be selected. Alternatively, regularization terms may be included in calculation. τ is a weight coefficient. As the weight coefficient τ becomes larger, an amount of reduction of redundant data becomes larger, and a compression rate increases. As the weight coefficient τ becomes smaller, convergence to a solution becomes weaker. The weight coefficient τ is set to such a proper value that f converges to a certain extent and is not excessively compressed.

Note that in the examples of FIG. 1B and FIG. 1C, an image coded by the filter array 110 is acquired in a blurred state on the imaging surface of the image sensor 160. Therefore, the hyperspectral image 220 can be generated by holding the blur information in advance and reflecting the blur information in the matrix H. The blur information is expressed by a point spread function (PSF). The PSF is a function that defines a degree of spread of a point image to surrounding pixels. For example, in a case where a point image corresponding to 1 pixel on an image spreads to a region of k×k pixels around the pixel due to blurring, the PSF can be defined as a coefficient group, that is, as a matrix indicative of influence on luminance of each pixel within the region. The hyperspectral image 220 can be generated by reflecting influence of blurring of a coding pattern by the PSF in the matrix H. Although the filter array 110 can be disposed at any position, a position where the coding pattern of the filter array 110 does not disappear due to excessive spread can be selected.

By the above processing, the hyperspectral image 220 can be generated on the basis of the compressed image 120 generated by imaging using the filter array 110 and the image sensor 160. The processing apparatus 200 generates and outputs the hyperspectral image 220 by applying a compressed sensing algorithm for all bands included in the target wavelength range. Specifically, the processing apparatus 200 causes the image sensor 160 to detect light reflected by the target 70 through the filter array 110 and thereby generate and output an image signal. The processing apparatus 200 generates the spectral image 220W₁ to the spectral image 200W_{N} on the basis of the image signal and N pieces of mask data corresponding to N wavelength bands obtained from the filter array 110 and outputs the spectral image 220W₁ to the spectral image 200W_{N}.

The N pieces of mask data may be first mask data H₁, . . . , i-th mask data Hᵢ, . . . , j-th mask data Hⱼ, . . . , and N-th mask data H_{N}.

H=(H₁ . . . Hᵢ . . . H_{N}), and each of the first mask data H₁, . . . , i-th mask data Hᵢ, . . . , j-th mask data Hⱼ, . . . , and N-th mask data H_{N} may be a submatrix of v×u rows and v×u columns. The i-th mask data Hᵢ and the j-th mask data Hⱼ are exemplified by the formula (4).

$$\begin{matrix}{H}_{i} = [ \begin{matrix}{i}_{11} & … & {i}_{1 ( v \times u )} \\ ⋮ & ⋱ & ⋮ \\ {i}_{( v \times u ) 1} & … & {i}_{( v \times u ) ( v \times u )}\end{matrix} ] \\ {H}_{j} = [ \begin{matrix}{j}_{11} & … & {j}_{1 ( v \times u )} \\ ⋮ & ⋱ & ⋮ \\ {j}_{( v \times u ) 1} & … & {j}_{( v \times u ) ( v \times u )}\end{matrix} ]\end{matrix} \qquad ( 4 )$$

### Relationship between Randomness of Mask Data and Reconstruction Error

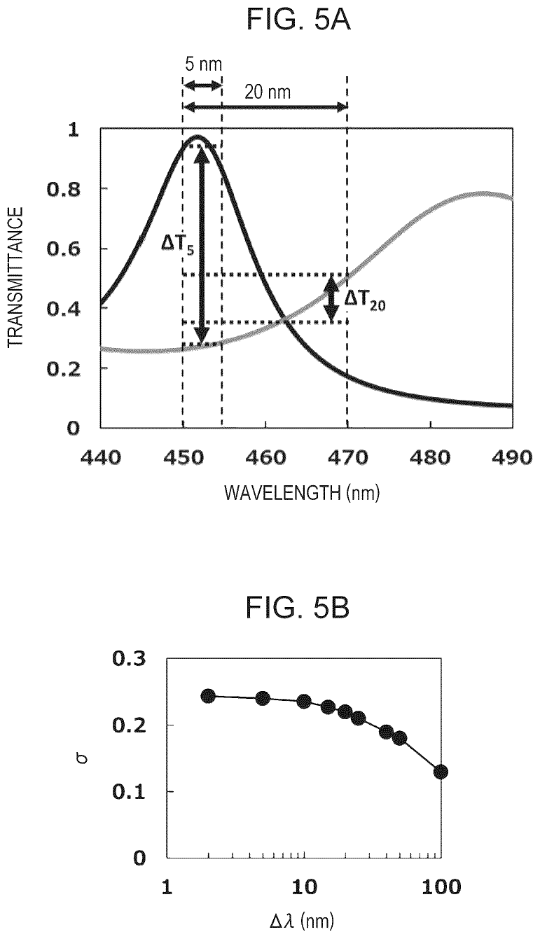

Next, influence given on reconstruction accuracy by randomness of the mask data of the filter array 110 in a space direction is described with reference to FIGS. 5A and 5B. FIG. 5A is a graph illustrating transmission spectra of two optical filters included in a certain filter array 110. ΔT₅ illustrated in FIG. 5A represents a difference in average transmittance between the two optical filters in a wavelength band having a width of 5 nm that is greater than or equal to 450 nm and less than or equal to 455 nm. ΔT₂₀ illustrated in FIG. 5A represents a difference in average transmittance between the two optical filters in a wavelength band having a width of 20 nm that is greater than or equal to 450 nm and less than or equal to 470 nm. As illustrated in FIG. 5A, ΔT₅>ΔT₂₀. This is because transmittance of an optical filter is averaged more in a wavelength direction as a width of a wavelength band, that is, wavelength resolution becomes wider. When transmittance of an optical filter is averaged in a wavelength direction and a difference in average transmittance between any two optical filters becomes small in the filter array 110, a spatial distribution of transmittance of the filter array 110 approaches a uniform distribution in a certain wavelength band. As a result, randomness of the mask data of the filter array 110 in the space direction decreases.

FIG. 5B is a graph illustrating a relationship between randomness of mask data of a certain filter array 110 in a space direction and wavelength resolution Δλ. As an index of randomness in the space direction, a standard deviation σμ of an average μ1 of transmittances corresponding to optical filters included in the filter array 110 concerning light of a first wavelength band to an average μN of transmittances corresponding to the optical filters included in the filter array 110 concerning light of an N-th wavelength band is used, as disclosed in Patent Literature 2. As the wavelength resolution Δλ becomes wider, the randomness of the mask data in the space direction decreases. As disclosed in Patent Literature 2, since the decrease in randomness in the space direction increases a reconstruction error of a hyperspectral image, the widening in wavelength resolution Δλ increases a reconstruction error of a hyperspectral image. The disclosure of Patent Literature 2 is incorporated herein by reference in its entirety. A method for calculating the standard deviation σμ disclosed in Patent Literature 2 is illustrated below.

An average of transmittances of the optical filters included in the filter array 110 concerning light of an i-th wavelength band (i is an integer greater than or equal to 1 and less than or equal to N) included in the N wavelength bands is expressed as μi. The filter array 110 includes M (M is an integer greater than or equal to 4) optical filters, and transmittance of a j-th (j is an integer greater than or equal to 1 and less than or equal to M) included in the M optical filters concerning light of the i-th wavelength band is Tij. The average μi of the transmittances is expressed by the following formula (5).

$${μ}_{i} = \frac{1}{M} {\sum }_{j = 1}^{M} {T}_{ij} \qquad ( 5 )$$

A standard deviation σμ of the averages μi of the transmittances concerning the N wavelength bands is expressed by the following formula (6).

$${σ}_{μ} = \frac{1}{N} \sqrt{{\sum }_{i = 1}^{N} {( {μ}_{i} - {μ}_{μ} )}^{2}} ( where {μ}_{μ} = \frac{1}{N} {\sum }_{i = 1}^{N} {μ}_{i} ) \qquad ( 6 )$$

Next, influence given on reconstruction accuracy by randomness of the mask data of the filter array 110 in the wavelength direction is described. In the following description, the target wavelength range includes N wavelength bands. For easier explanation, it is assumed that the N wavelength bands are given numbers in an ascending order of a central wavelength. A wavelength band having a shorter central wavelength is given a smaller number. The N wavelength bands may be given numbers in a descending order of a central wavelength. However, such numbering of the wavelength bands is not essential.

The randomness of the mask data in the wavelength direction is evaluated by using a correlation coefficient rᵢⱼ between i-th mask data concerning an i-th wavelength band and j-th mask data concerning a j-th wavelength band where i and j are integers greater than or equal to 1 and less than or equal to N. The image sensor 160 detects light corresponding to a certain wavelength band among the N wavelength bands and outputs mask data according to a pixel value distribution corresponding to the wavelength band. In this way, the i-th and j-th mask data can be acquired. In a case where only light corresponding to a certain wavelength band is detected by the image sensor 160, light of a wavelength that is shifted by several nm from a wavelength range corresponding to the certain wavelength band may be incident. That is, light of a wavelength shorter by several nm than a lower limit of the wavelength range corresponding to the certain wavelength band or light of a wavelength longer by several nm than an upper limit of the wavelength range corresponding to the certain wavelength band may be incident on the image sensor 160.

The correlation coefficient rᵢⱼ is expressed by the following formula (3) as a two-dimensional correlation coefficient.

$${r}_{i j} = \vert \frac{{\sum }_{m} {\sum }_{n} ( {i}_{m n} - {i}_{0} ) ( {j}_{m n} - {j}_{0} )}{\sqrt{( {\sum }_{m} {\sum }_{n} {( {i}_{m n} - {i}_{0} )}^{2} ) ( {\sum }_{m} {\sum }_{n} {( {j}_{m n} - {j}_{0} )}^{2} )}} \vert \qquad ( 3 )$$

The correlation coefficient rᵢⱼ expressed by the formula (3) is an index indicative of a degree of similarity between mask data of the wavelength band i and mask data of the wavelength band j. As the similarity becomes higher, the correlation coefficient rᵢⱼ becomes closer to 1, and in a case where the mask data of the wavelength band i and the mask data of the wavelength band j completely match, the correlation coefficient rᵢⱼ is 1. On the contrary, as the similarity becomes lower, the correlation coefficient rᵢⱼ becomes closer to 0, and in a case where there is no correlation, the correlation coefficient rᵢⱼ is 0.

The correlation coefficient rᵢⱼ expressed by the formula (3) is calculated on the basis of v×u×v×u components included in the i-th mask data corresponding to the i-th wavelength band, that is, a matrix Hᵢ and v×u×v×u components included in the j-th mask data corresponding to the j-th wavelength band, that is, a matrix Hⱼ. In the formula (3), iₘₙ is a (m, n) component included in the i-th mask data Hᵢ, that is, the matrix Hᵢ. In the formula (3), jₘₙ is a (m, n) component included in the j-th mask data Hⱼ, that is, the matrix Hⱼ. i₀ is an average of all components included in the i-th mask data, that is, the matrix Hᵢ. That is, i₀=(i₁₁+ . . . +i_{(v×u)(v×u)})/(v×u×v×u). j₀ is an average of all components included in the j-th mask data, that is, the matrix Hⱼ. That is, j₀=(j₁₁+ . . . +j_{(v×u)(v×u)})/(v×u×v×u).

A correlation coefficient r₁₁, . . . , the correlation coefficient rᵢⱼ, . . . , a correlation coefficient r_{NN} may be expressed by a matrix R indicated by the formula (7).

$$R = [ \begin{matrix}{r}_{11} & … & {r}_{1 N} \\ ⋮ & ⋱ & ⋮ \\ {r}_{N 1} & … & {r}_{NN}\end{matrix} ] \qquad ( 7 )$$

r₁₁=1, r₂₂=1, . . . , r_{NN}=1. rᵢⱼ (i≠j) expresses a degree of similarity between the i-th mask data Hⱼ corresponding to the wavelength band i and the j-th mask data Hⱼ corresponding to the wavelength band j and contributes to wavelength resolution and reconstruction accuracy of a hyperspectral image. The following is established: rᵢⱼ=rⱼᵢ. In a case where the wavelength bands are given numbers in an ascending order of a central wavelength, the correlation coefficients rᵢⱼ are arranged from left to right and up to down in an ascending order of a central wavelength of a wavelength band.

It may be interpreted that the i-th mask data Hᵢ indicates a transmittance distribution of the filter array 110 concerning light of the i-th wavelength band. It may be interpreted that the j-th mask data Hⱼ indicates a transmittance distribution of the filter array 110 concerning light of the j-th wavelength band.

The i-th mask data Hᵢ, that is, the matrix Hᵢ may be a diagonal matrix.

It may be interpreted that i₁₁, which is a (1, 1) component included in the matrix Hᵢ, is transmittance of a first optical filter included in the filter array 110 concerning light of the i-th wavelength band, i₂₂, which is a (2, 2) component included in the matrix Hᵢ, is transmittance of a second optical filter included in the filter array 110 concerning light of the i-th wavelength band, . . . , and i_{(v×u)(v×u)}, which is a (v×u, v×u) component included in the matrix Hᵢ indicates transmittance of a (v×u)-th optical filter included in the filter array 110 concerning light of the i-th wavelength band.

The j-th mask data Hⱼ, that is, the matrix Hⱼ may be a diagonal matrix.

It may be interpreted that j₁₁, which is a (1, 1) component included in the matrix Hⱼ, indicates transmittance of the first optical filter included in the filter array 110 concerning light of the j-th wavelength band, j₂₂, which is a (2, 2) component included in the matrix Hⱼ indicates transmittance of the second optical filter included in the filter array 110 concerning light of the j-th wavelength band, . . . , and j_{(v×u)(v×u)}, which is a (v×u, v×u) component included in the matrix Hⱼ indicates transmittance of the (v×u)-th optical filter included in the filter array 110 concerning light of the j-th wavelength band.

It may be interpreted that i₀=(i₁₁+ . . . +i_{(v×u)(v×u)})/(v×u×v×u), which is an average of all components included in the i-th mask data, that is, the matrix Hᵢ is an average of transmittances corresponding to the optical filters included in the filter array 110 concerning light of the i-th wavelength band.

It may be interpreted that j₀=(j₁₁+ . . . +j_{(v×u)(v×u)})/(v×u×v×u), which is an average of all components included in the j-th mask data, that is, the matrix Hᵢ is an average of transmittances corresponding to optical filters included in the filter array 110 concerning light of the j-th wavelength band.

Examples of a case where each of matrix H₁, . . . , matrix Hᵢ, . . . , matrix Hⱼ, . . . , matrix H_{N} is a diagonal matrix of v×u rows and v×u columns include a case where it is determined that crosstalk between a pixel (p, q) and a pixel (r, s) of the image sensor 160 during actual calibration for acquiring information concerning the matrix H and crosstalk between the pixel (p, q) and the pixel (r, s) of the image sensor 160 at a time when an end user images the subject 70 are identical (1≤p, r≤v, 1≤q, s≤u, the pixel (p, q)≠the pixel (r, s)). Whether or not the condition concerning crosstalk is satisfied may be determined in consideration of an imaging environment including an optical lens and the like used during imaging or may be determined in consideration of whether or not image quality of each reconstructed image can accomplish an objective of the end user.

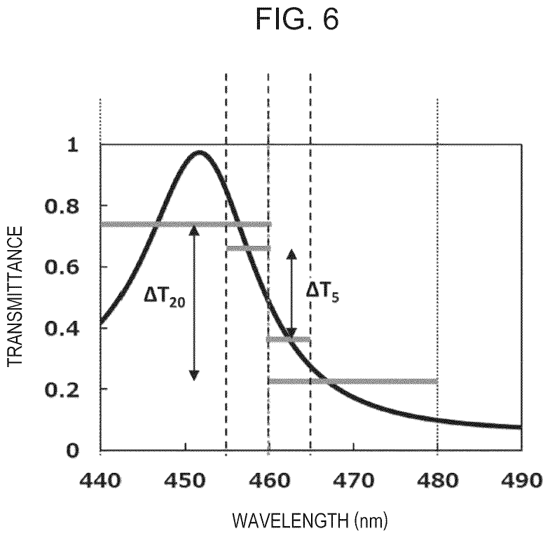

Next, a difference in average transmittance between two adjacent wavelength bands is described with reference to FIG. 6. FIG. 6 is a graph illustrating a transmission spectrum of an optical filter included in a certain filter array 110. In the example illustrated in FIG. 6, in a case where each of two wavelength bands divided at 460 nm has wavelength resolution of 20 nm, a difference between average transmittance of the optical filter concerning a wavelength band greater than or equal to 440 nm and less than or equal to 460 nm and average transmittance of the optical filter concerning a wavelength band greater than or equal to 460 nm and less than or equal to 480 nm is expressed as ΔT₂₀ . In the example illustrated in FIG. 6, in a case where each of two wavelength bands divided at 460 nm has wavelength resolution of 5 nm, a difference between average transmittance of the optical filter concerning a wavelength band greater than or equal to 455 nm and less than or equal to 460 nm and average transmittance of the optical filter concerning a wavelength band greater than or equal to 460 nm and less than or equal to 465 nm is expressed as ΔT₅. In the example illustrated in FIG. 6, ΔT₂₀>ΔT₅.

As illustrated in FIG. 6, a difference in average transmittance between two adjacent wavelength bands in a certain optical filter depends on wavelength resolution. The following can be basically said although there are differences based on transmission characteristics of an optical filter. Assume that a transmission peak of an optical filter is approximately expressed by a Lorenz function. In a case where wavelength resolution is approximately two times as large as a half width of the transmission peak of the optical filter, a difference in average transmittance between two adjacent wavelength bands is almost maximum. On the other hand, as the wavelength resolution becomes excessively wider than (three or more times as large as) or excessively narrower than (0.5 times as large as) the half width of the transmission peak of the optical filter, a difference in average transmittance between two adjacent wavelength bands becomes smaller.

The half width of the transmission peak of the optical filter may be |λ2−λ1| or |λ4−λ3|.

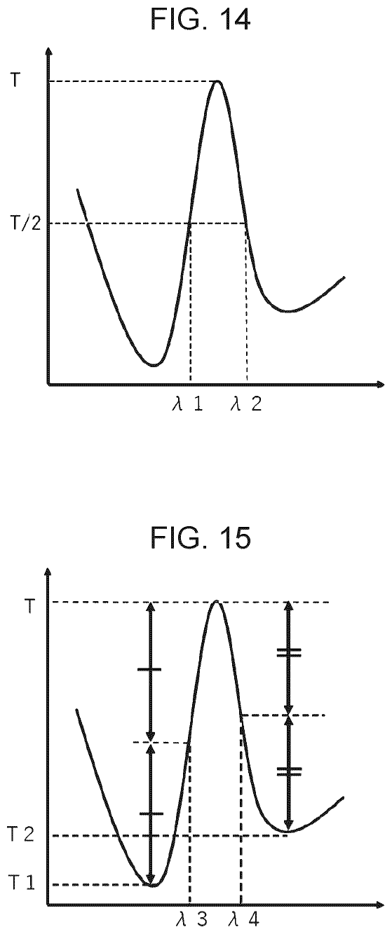

FIG. 14 is a view for explaining that the half width of the transmission peak of the optical filter is |λ2−λ1|. The vertical axis of the graph illustrated in FIG. 14 represents transmittance of the optical filter, and the horizontal axis of the graph illustrated in FIG. 14 represents a wavelength. In FIG. 14, λ1 is a wavelength corresponding to T/2, λ2 is a wavelength corresponding to T/2, and T is a peak value of transmittance of the optical filter.

FIG. 15 is a view for explaining that the half width of the transmission peak of the optical filter is |λ4−λ3|. The vertical axis of the graph illustrated in FIG. 15 represents transmittance of the optical filter, and the horizontal axis of the graph illustrated in FIG. 15 represents a wavelength. In FIG. 15, λ3 is a wavelength corresponding to (T−T1)/2, λ4 is a wavelength corresponding to (T−T2)/2, T is a local maximum value of transmittance of the optical filter, T1 is a first local minimum value adjacent to the local maximum value T, and T2 is a second local minimum value adjacent to the local maximum value T.

As a difference in average transmittance between two adjacent wavelength bands becomes larger, mask data of the two wavelength bands are “less similar”, and rᵢⱼ (i≠j) of the matrix R becomes closer to 0. In a case where rᵢⱼ (i≠j) of the matrix R is sufficiently small, the i-th wavelength band and the j-th wavelength band can be separated. That is, it can be said that the “wavelengths” are “separable”. Whether or not wavelength bands are separable is determined depending on wavelength resolution. The wavelength resolution influences a reconstruction result. In a case where rᵢⱼ (i≠j) of the matrix R is sufficiently small, the rᵢⱼ (i≠j) is, for example, 0.8 or less.

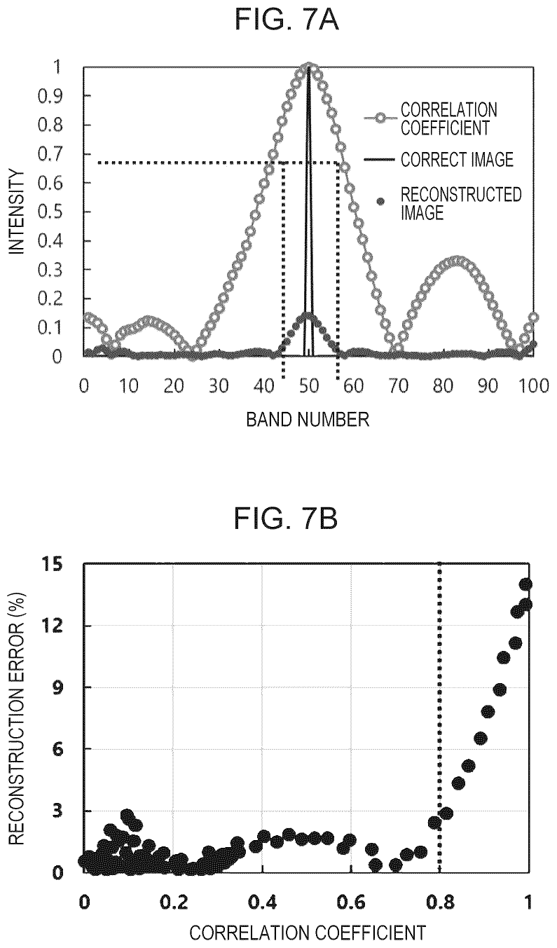

Next, a condition on which the i-th wavelength band and the j-th wavelength band corresponding to rᵢⱼ (i≠j) of the matrix R are separable is described with reference to FIGS. 7A and 7B. FIG. 7A is a graph illustrating a correlation coefficient, a spectrum of a correct image, and a spectrum of a reconstruction image in a case where a hyperspectral image concerning 100 wavelength bands within a target wavelength range is generated by using a certain filter array 110. The correlation coefficient is rᵢⱼ with respect to the fiftieth wavelength band where i=50 and 1≤j≤100. The spectrum of the correct image exhibits an intensity of 1 in the fiftieth wavelength band and exhibits an intensity of zero in remaining 99 wavelength bands. An intensity of the correct image in each wavelength band is a value obtained by dividing an average of intensities of all pixels included in the correct image by a maximum intensity that can be observed (an intensity 255 in an 8-bit image). An intensity 1 corresponds to white, and an intensity zero corresponds to black. The solid line illustrated in FIG. 7A represents the spectrum of the correct image, the black circles represent the spectrum of the reconstruction image, and the white circles represent the correlation coefficient.

As illustrated in FIG. 7A, the spectrum of the correct image exhibits a non-zero intensity only in the fiftieth wavelength band, whereas the spectrum of the reconstruction image exhibits a non-zero intensity not only in the fiftieth wavelength band, but also in surrounding bands. An intensity of the reconstruction image in each wavelength band is an average of intensities of all pixels included in the reconstruction image. As is clear from the correlation function illustrated in FIG. 7A, a reason why the spectrum of the reconstruction image exhibits such an intensity is that mask data concerning the fiftieth wavelength band and mask data concerning the surrounding wavelength bands are similar. As a result, an intensity that should be allocated to the fiftieth wavelength band is erroneously allocated to the surrounding wavelength bands.

FIG. 7B is a graph in which relationships between correlation coefficients concerning the 99 wavelength bands other than the fiftieth wavelength band and reconstruction errors are plotted from the result illustrated in FIG. 7A. As for the 99 wavelength bands other than the fiftieth wavelength band, the intensity of the reconstruction image is a reconstruction error since the intensity of the correct image is 0. That is, in a case where an average pixel value of an 8-bit reconstruction image is x, the reconstruction error is x/255×100 (%). In a case where the correlation coefficient is 0.8 or less, the reconstruction error is 3% or less. On the other hand, in a case where the correlation coefficient is 0.8 or more, the reconstruction error rapidly increases as the correlation coefficient increases. For example, in a case where the correlation coefficient is 0.9, the reconstruction error is approximately 7%. The rapid increase in reconstruction error means that pieces of mask data whose correlation coefficient is 0.8 or more strongly influence each other's calculation results. In the example illustrated in FIG. 7A, a spectrum of a correct reconstruction image is supposed to exhibit an intensity of zero in the wavelength bands other than the fiftieth wavelength band. Actually, mask data of the fiftieth wavelength band and mask data of the surrounding wavelength bands influence each other, and as a result the spectrum of the reconstruction image exhibits an intensity of approximately 0.07 in the surrounding bands.

As illustrated in FIG. 7A, similarity of mask data between two wavelength bands can be calculated on the basis of a correlation coefficient. As illustrated in FIG. 7B, pieces of mask data whose correlation coefficient is 0.8 or more are similar to each other and influence each other's calculation results.

As is understood from the above description, change in wavelength resolution may decrease randomness of mask data of the filter array 110 in a space direction and a wavelength direction, resulting in an increase in reconstruction error of a hyperspectral image. Since a reconstruction error of a hyperspectral image depends on wavelength resolution, an approximate reconstruction error can be estimated for each wavelength band by determining wavelength resolution.

### Example of System for Estimating Reconstruction Error of Hyperspectral Image

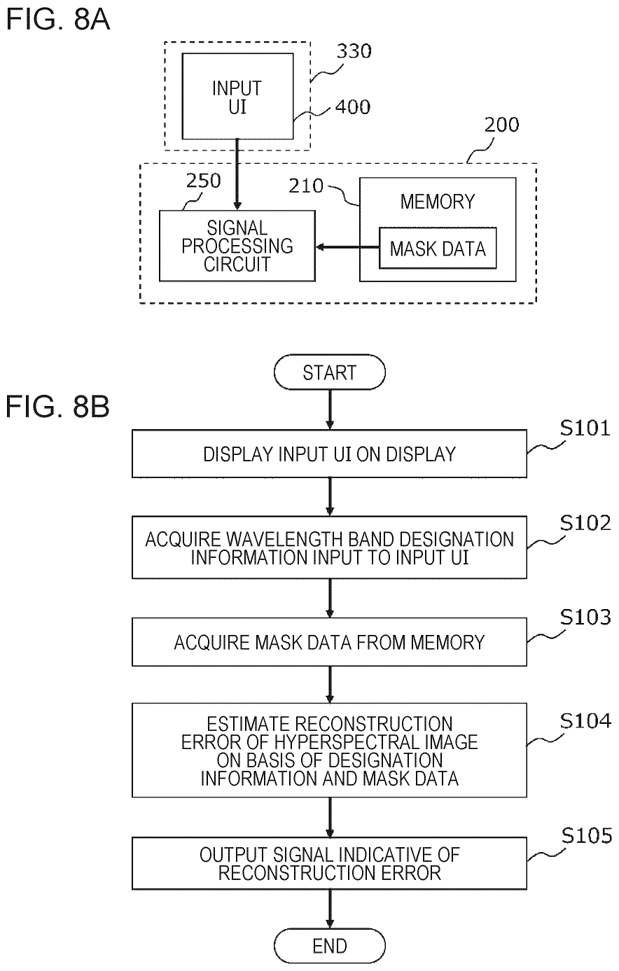

An example of a system for estimating a reconstruction error of a hyperspectral image according to the present embodiment is described below. First, a first example of the system according to the present embodiment is described with reference to FIGS. 8A and 8B. FIG. 8A is a block diagram schematically illustrating the first example of the system according to the present embodiment. The system illustrated in FIG. 8A includes the processing apparatus 200 and a display 330 connected to the processing apparatus 200.

The processing apparatus 200 includes a signal processing circuit 250 and a memory 210 in which mask data of the filter array 110 is stored. The mask data of the filter array 110 may be distributed via a server. The memory 210 further stores therein a computer program to be executed by a processor included in the signal processing circuit 250. The signal processing circuit 250 can be, for example, an integrated circuit including a processor such as a CPU or a GPU. The memory 210 can be, for example, a RAM and a ROM.

The display 330 displays an input user interface (UI) 400 for allowing a user to input a reconstruction condition and an imaging condition. The input UI 400 is displayed as a graphical user interface (GUI). It can be said that information displayed on the input UI 400 is displayed on the display 330.

The input UI 400 can include, for example, an input device such as a keyboard and a mouse. The input UI 400 may be realized by a device, such as a touch screen, that enables both input and output. In this case, the touch screen may also function as the display 330.

The reconstruction condition is, for example, wavelength resolution and reconstruction parameters used for estimation of a reconstruction error. The reconstruction parameters can be, for example, the weight τ of the evaluation function expressed by the formula (2) and the number of iterations of iterative calculation for minimizing the evaluation function. The imaging condition is, for example, an exposure period and a frame rate during imaging.

The reconstruction condition may be set by a user together with the imaging condition. Alternatively, one or some of reconstruction conditions may be set by a manufacturer in advance, and remaining reconstruction conditions may be set by a user. The signal processing circuit 250 estimates a reconstruction error on the basis of the set wavelength resolution and the mask data.

FIG. 8 is a flowchart schematically illustrating an example of operation performed by the signal processing circuit 250 in the system illustrated in FIG. 8A. The signal processing circuit 250 performs operations in steps 5101 to 5105 illustrated in FIG. 8B.

### Step S101

The signal processing circuit 250 causes the input UI 400 to be displayed on the display 330. A user inputs, on the input UI 400, designation information for designating N (N is an integer greater than or equal to 4) wavelength bands corresponding to N spectral images. The designation information includes information indicative of wavelength resolution corresponding to each of the N spectral images. The designation information may include a lower-limit wavelength and an upper-limit wavelength of each of the N wavelength bands.

### Step S102

The signal processing circuit 250 acquires the designation information input to the input UI 400.

### Step S103

The signal processing circuit 250 acquires the mask data from the memory 210. The mask data reflects a spatial distribution of spectral transmittance of the filter array 110 concerning each of the N wavelength bands. As the mask data, pieces of mask data corresponding to different pieces of designation information may be prepared in advance, and mask data corresponding to the designation information input on the input UI 400 may be acquired. Alternatively, the mask data corresponding to the designation information may be generated by performing conversion on mask data on the basis of the designation information. A method for generating the mask data corresponding to the designation information is, for example, described in WO2021/192891.

### Step S104

The signal processing circuit 250 estimates a reconstruction error of a hyperspectral image on the basis of the designation information and the mask data. Specifically, the signal processing circuit 250 calculates an index σ of randomness in a space direction and an index rᵢⱼ of randomness in a wavelength direction on the basis of the designation information and the mask data and estimates the reconstruction error on the basis of calculated σ and calculated rᵢⱼ. In the estimation of the reconstruction error, for example, a reconstruction error (MSE space) based on randomness in the space direction is estimated from calculated σ by using the method of Patent Literature 2, and a reconstruction error (MSE_{spectral}) based on randomness in the wavelength direction is estimated from calculated rᵢⱼ on the basis of the relationship of FIG. 7B, and a total reconstruction error (MSEₜₒₜₐₗ)can be estimated by using a law of propagation of errors assuming that the two reconstruction errors are independent of each other. According to the law of propagation of errors, MSEₜₒₜₐₗ=√((MSE_{space})²+(MSE_{spectral})²). Instead of using σ as an index representing randomness in the space direction, for example, σ/μ obtained by dividing σ by average transmittance μ of the filter array 110 may be used. The index of randomness in the wavelength direction is not limited to rᵢⱼ expressed by the formula (3), and another index indicative of similarity of mask data between two wavelength bands may be used.

In the estimation of the reconstruction error, the signal processing circuit 250 extracts i-th and j-th mask data from the mask data on the basis of the designation information and estimates a reconstruction error on the basis of a correlation coefficient of the i-th and j-th mask data. The i-th and j-th mask data reflect spatial distributions of transmittances of the filter array 110 corresponding to the i-th and j-th wavelength bands among the N wavelength bands, respectively.

### Step S105

The signal processing circuit 250 outputs a signal indicative of the estimated reconstruction error. An output destination of the signal is decided depending on an intended purpose and can be, for example, the display 330 or another signal processing circuit.

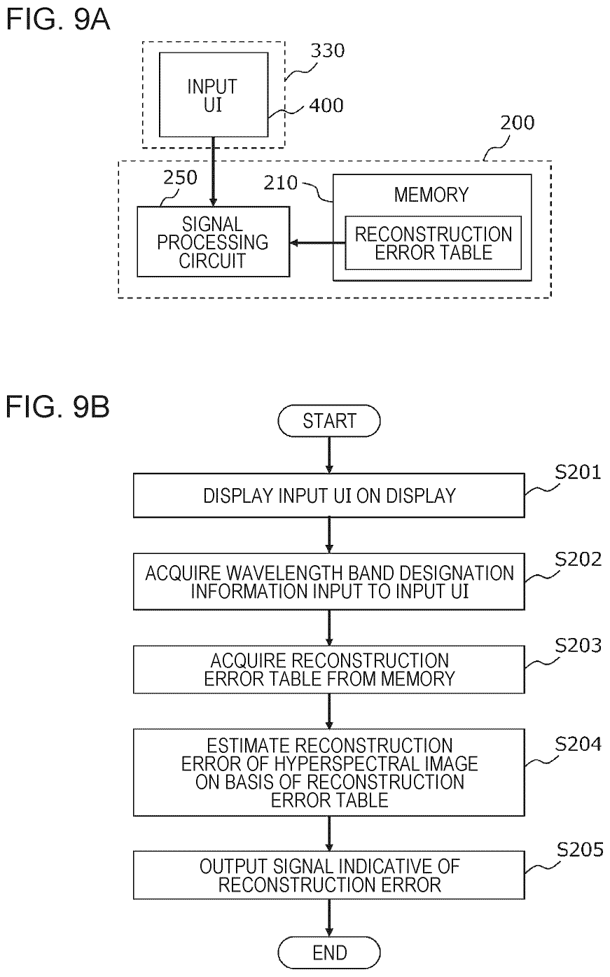

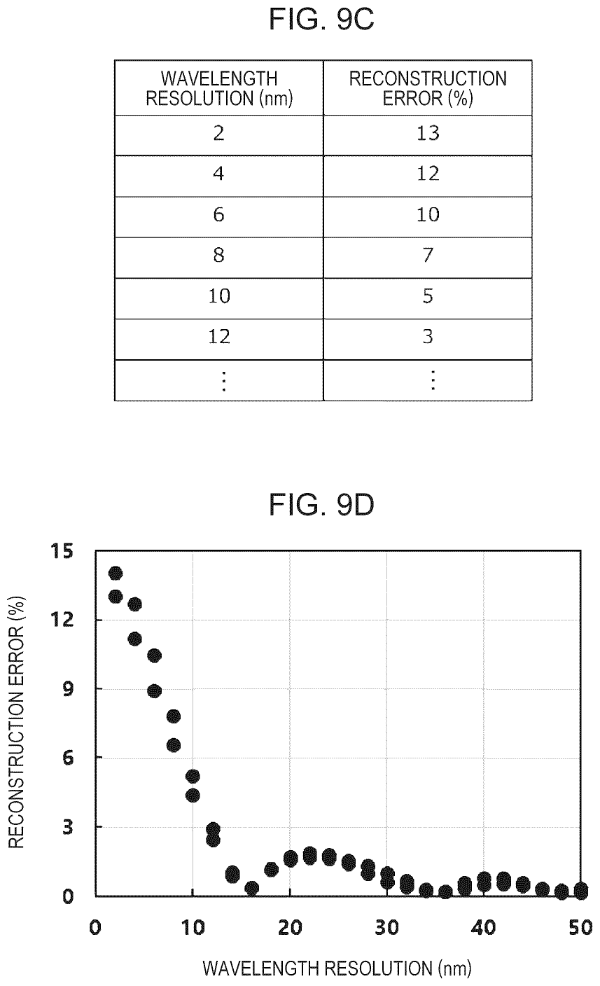

Next, a second example of the system according to the present embodiment is described with reference to FIGS. 9A to 9D. A reconstruction error of a hyperspectral image can be estimated by acquiring not the mask data but data indicative of a relationship between wavelength resolution associated with the mask data and a reconstruction error. Hereinafter, such data is referred to as a “reconstruction error table”.

FIG. 9A is a block diagram schematically illustrating the second example of the system according to the present embodiment. The system illustrated in FIG. 9A is different from the system illustrated in FIG. 8A in that the memory 210 stores therein reconstruction error data. The mask data is data of a large information amount, specifically, the number of pixels×the number of wavelengths. A data amount acquired from the memory 210 or a data amount distributed from a server when estimating a reconstruction error can be reduced by using not the mask data but the reconstruction error table.

FIG. 9B is a flowchart schematically illustrating an example of operation performed by the signal processing circuit 250 in the system illustrated in FIG. 9A. The signal processing circuit 250 performs operations in steps S201 to S205 illustrated in FIG. 9B.

### Steps S201, S202, and S205

The operations in step S201, S202, and S205 are identical to the operations in steps S101, S102, and S105 illustrated in FIG. 8B, respectively.

### Step S203

The signal processing circuit 250 acquires the reconstruction error data from the memory 210.

### Step S204

The signal processing circuit 250 estimates a reconstruction error of a hyperspectral image on the basis of the designation information and the reconstruction error table.

FIG. 9C is a table illustrating an example of the reconstruction error table. The reconstruction error table illustrated in FIG. 9C includes information concerning a relationship between wavelength resolution and a reconstruction error. The reconstruction error table makes it possible to find a reconstruction error on the basis of wavelength resolution. The wavelength resolution may be expressed not by nm but by another uniquely convertible unit such as a frequency Hz or a wave number cm⁻¹. The reconstruction error may be expressed not by a percentage % but by another uniquely convertible unit or index such as an MSE or a PSNR.

Although the reconstruction error table illustrated in FIG. 9C is a table of specific numerical values, the reconstruction error may be expressed as a function of the wavelength resolution. FIG. 9D is a graph illustrating an example in which the reconstruction error is expressed as a function of the wavelength resolution. The horizontal axis represents wavelength resolution, and the vertical axis represents a reconstruction error. The graph illustrated in FIG. 9D can be obtained from the results illustrated in FIGS. 7A and 7B.

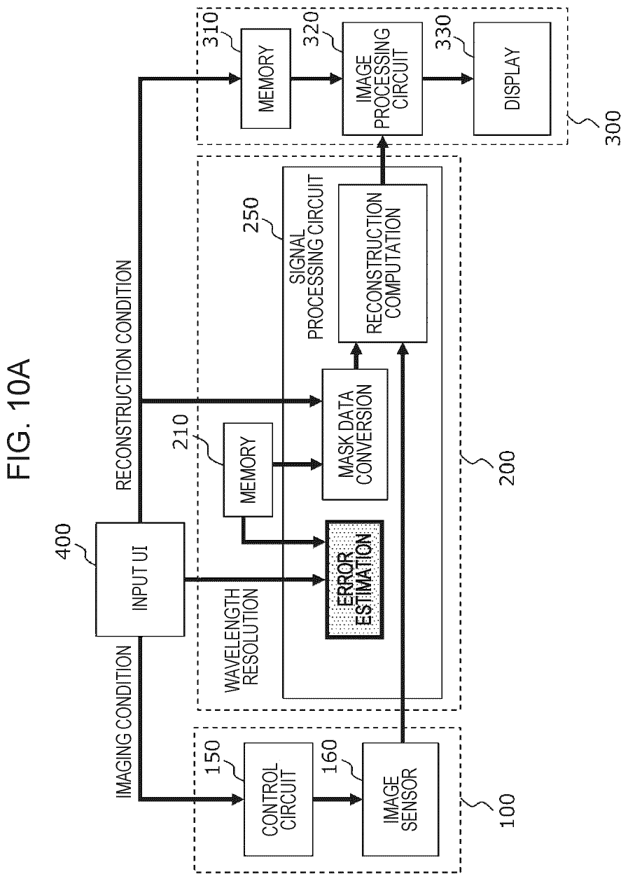

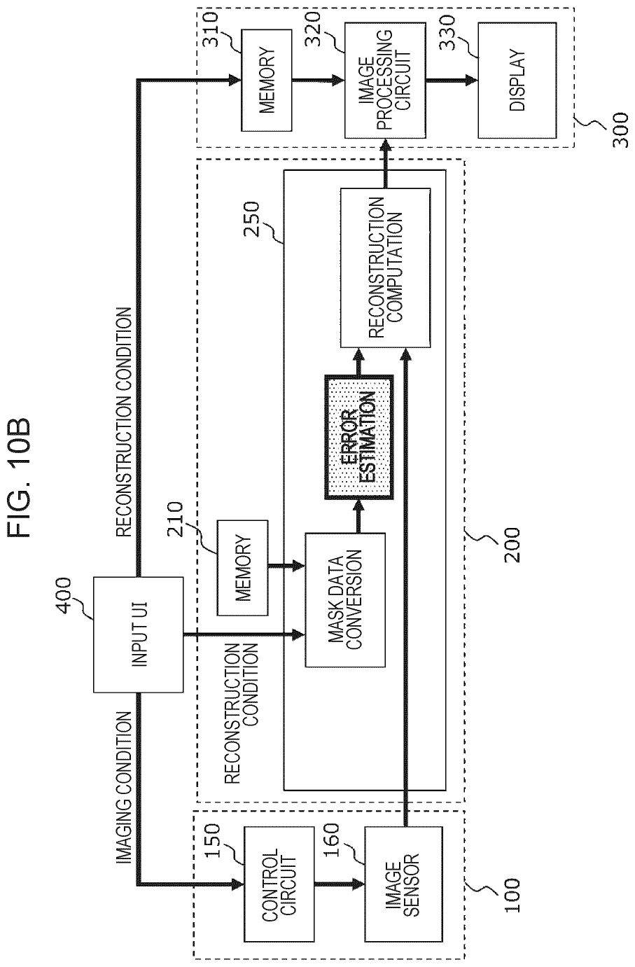

Next, a third example of the system according to the present embodiment is described with reference to FIGS. 10A and 10B. In a case where the compressed sensing technique is applied to a hyperspectral camera, signal compression and reconstruction are performed not only in a space direction but also in a wavelength direction. By averaging mask data in wavelength bands at a time of signal reconstruction in the wavelength direction, the wavelength bands can be handled as a single wavelength band. In such mask data conversion processing, wavelength resolution can be determined at a time of reconstruction computation (International Publication No. 2021/192891). That is, the wavelength resolution is not fixed by camera hardware and can be changed by a manufacturer or a user. The disclosure of International Publication No. 2021/192891 is incorporated herein by reference in its entirety.

FIGS. 10A and 10B are block diagrams schematically illustrating a third example and a fourth example of the system according to the present embodiment, respectively. Each of the systems illustrated in FIGS. 10A and 10B includes the imaging device 100, the processing apparatus 200, the display 300, and the input UI 400. The imaging device 100, the display 300, and the input UI 400 are connected to the processing apparatus 200. A user inputs a reconstruction condition and an imaging condition to the input UI 400.

The imaging device 100 includes a control circuit 150 and an image sensor 160. The control circuit 150 acquires the imaging condition and controls imaging operation of the image sensor 160 on the basis of the imaging condition.

The processing apparatus 200 includes the memory 210 and the signal processing circuit 250. The signal processing circuit 250 acquires the reconstruction condition and converts the mask data on the basis of the reconstruction condition. The signal processing circuit 250 generates a spectral image and outputs an image signal thereof by reconstruction computation based on the converted mask data and a compressed image output from the image sensor 160. The signal processing circuit 250 further estimates a reconstruction error.

The display 300 includes the memory 310, the image processing circuit 320, and the display 330. The memory 310 acquires the reconstruction condition. The image processing circuit 320 acquires the image signal output from the signal processing circuit 250 and processes the image signal on the basis of the reconstruction condition. The display 330 displays a result of the image processing. The display 330 may display the input UI 400.

In the example illustrated in FIG. 10A, the signal processing circuit 250 acquires wavelength resolution from the input UI 400, acquires the mask data or the reconstruction error table from the memory 210, and estimates the reconstruction error. The signal processing circuit 250 further converts the mask data. Although an order of the estimation of the reconstruction error and the conversion of the mask data is not limited, the mask data conversion processing can be omitted in a case where the reconstruction error is large by estimating the reconstruction error before converting the mask data. Furthermore, the user can get feedback indicating that the reconstruction error is large through the display 330.

In the example illustrated in FIG. 10B, the signal processing circuit 250 estimates the reconstruction error after converting the mask data. Since the mask data after conversion includes information on wavelength resolution, acquisition of the wavelength resolution from the input UI 400 can be omitted.

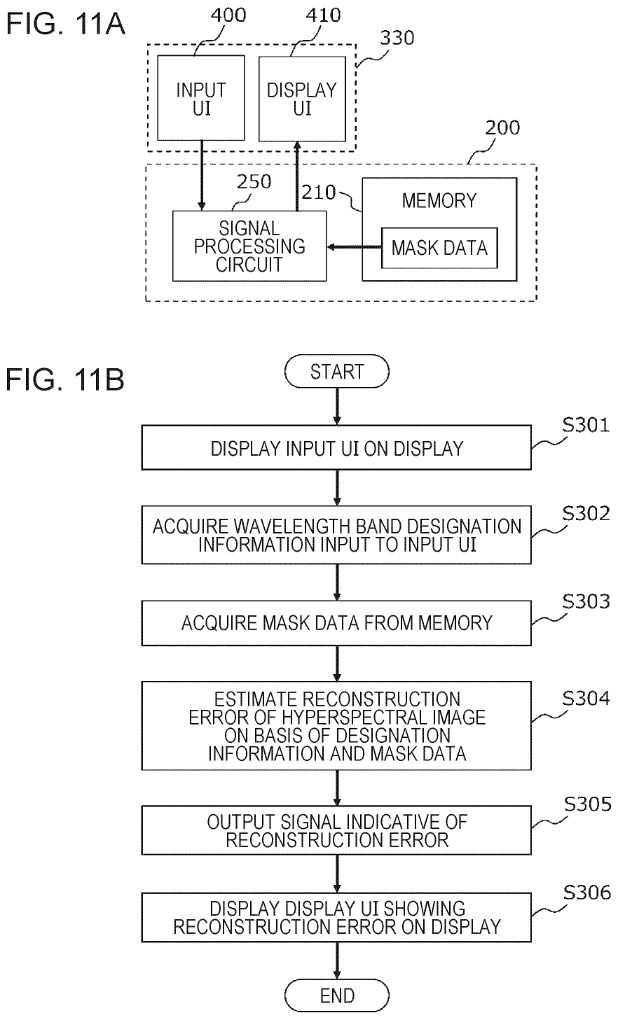

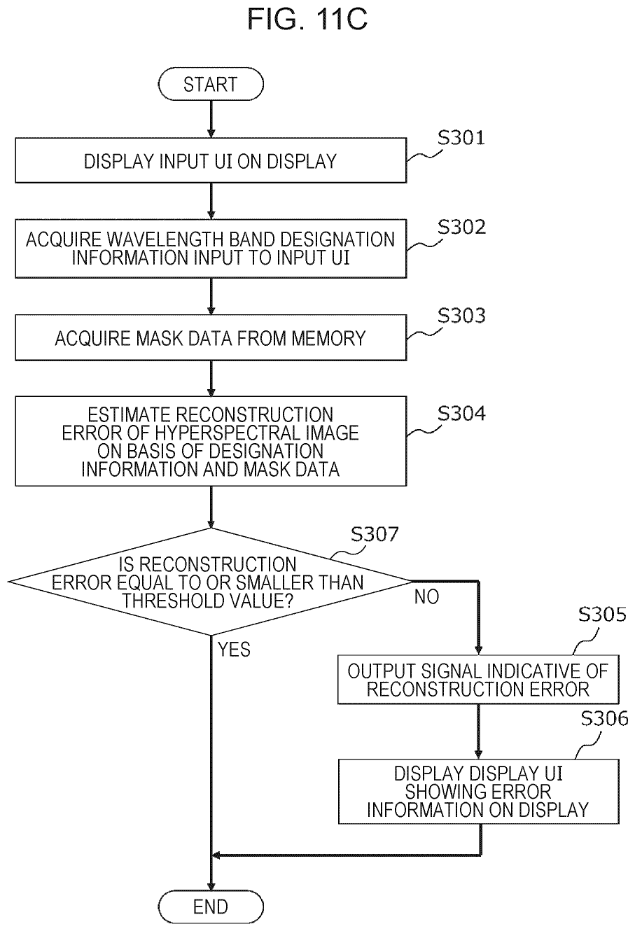

Next, a fifth example of the system according to the present embodiment is described with reference to FIGS. 11A to 11C. FIG. 11A is a block diagram schematically illustrating the fifth example of the system according to the present embodiment. The system illustrated in FIG. 11A is different from the system illustrated in FIG. 8A in that the display 330 displays not only the input UI 400, but also a display UI 410 showing a reconstruction error. A function of the display UI 410 is identical to the function of the input UI 400. The display UI 410 is displayed as a GUI. It can be said that information displayed on the display UI 410 is displayed on the display 330. The display UI 410 may be displayed not on the display 330 but on another display.

FIG. 11B is a flowchart schematically illustrating an example of operation performed by the signal processing circuit 250 in the system illustrated in FIG. 11A. The signal processing circuit 250 performs operations in steps S301 to S306 illustrated in FIG. 11B.

### Steps S301 to S305

The operations in steps S301 to S305 are identical to the operations in steps S101 to S105 illustrated in FIG. 8B. Note that data acquired by the signal processing circuit 250 in step S303 may be a reconstruction error table instead of mask data. In step S305, the signal processing circuit 250 outputs a signal indicative of a reconstruction error to the display 330.

### Step S306

The signal processing circuit 250 causes the display UI 410 showing the reconstruction error to be displayed on the display 330.

FIG. 11C is a flowchart schematically illustrating another example of operation performed by the signal processing circuit 250 in the system illustrated in FIG. 11A. The signal processing circuit 250 performs an operation in step S307 illustrated in FIG. 11C between steps S304 and S305 among steps S301 to S306 illustrated in FIG. 11B.

### Step S307

The signal processing circuit 250 determines whether or not the reconstruction error is equal to or smaller than a predetermined threshold value. The threshold value may be set in advance by a manufacturer or may be set by a user by using the input UI 400. In a case where a result of the determination is Yes, the signal processing circuit 250 ends the operation. In a case where the result of the determination is No, the signal processing circuit 250 performs the operation in step S305.

### Example of Display UI

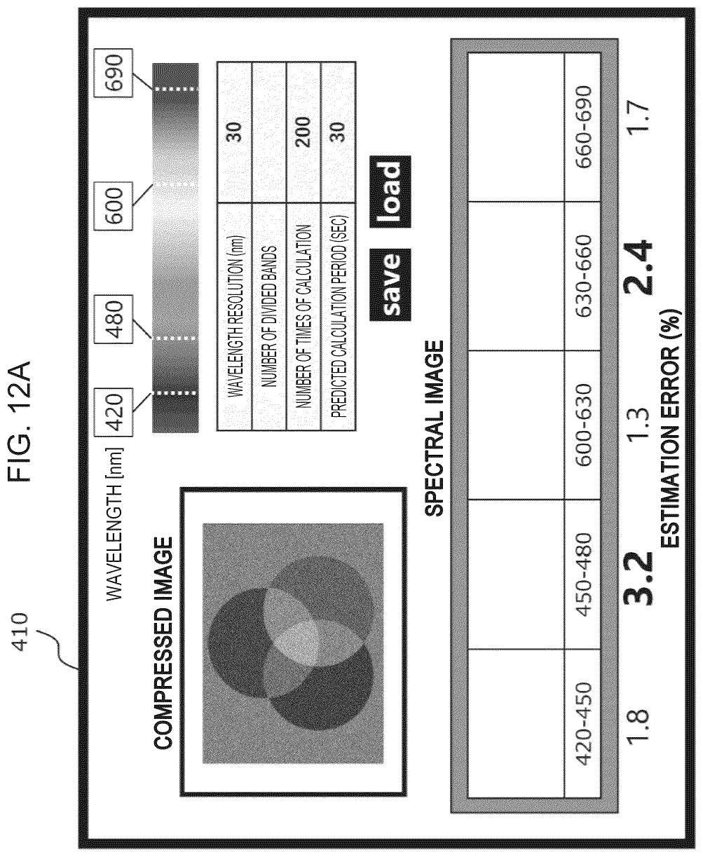

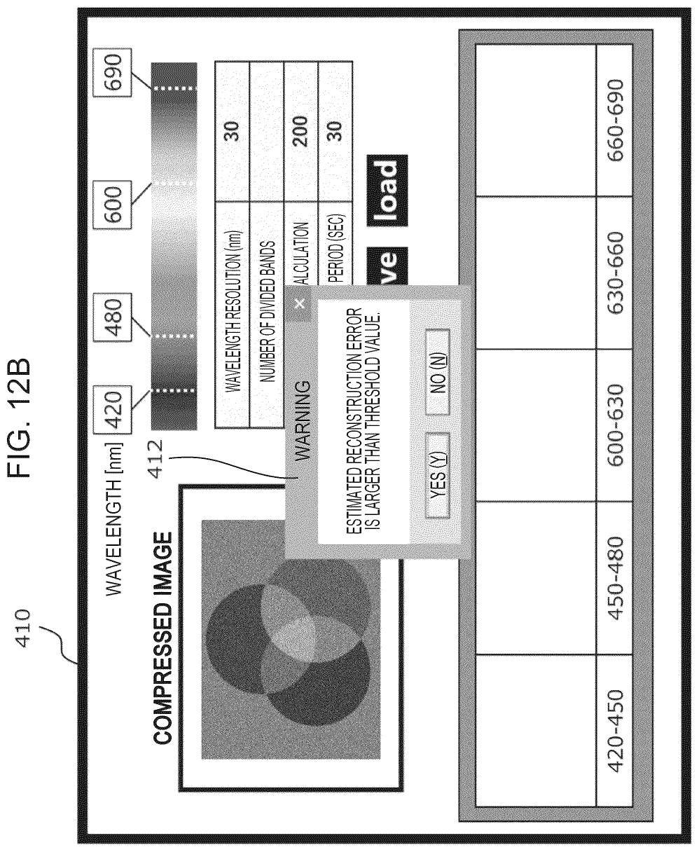

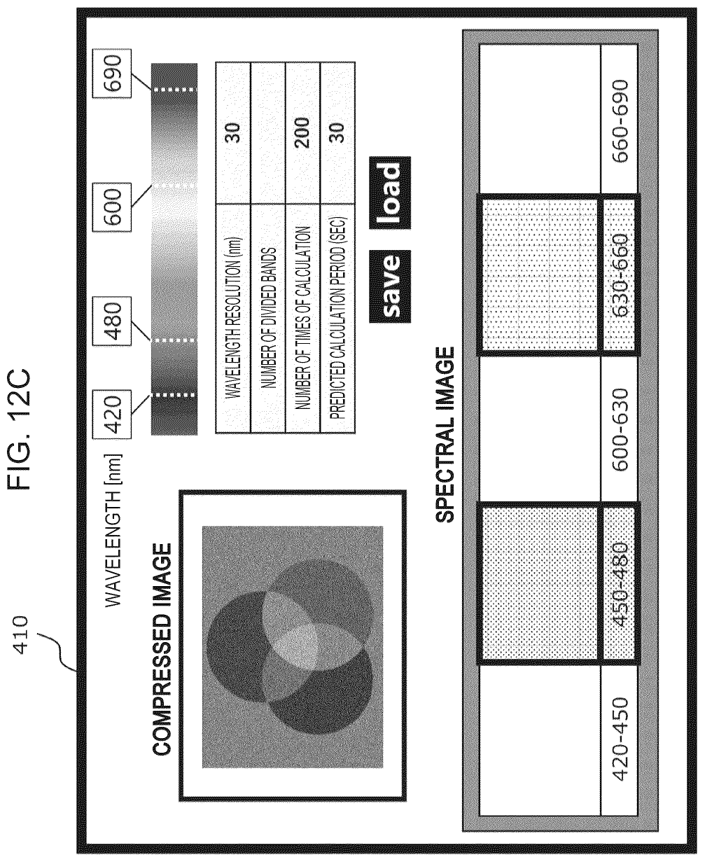

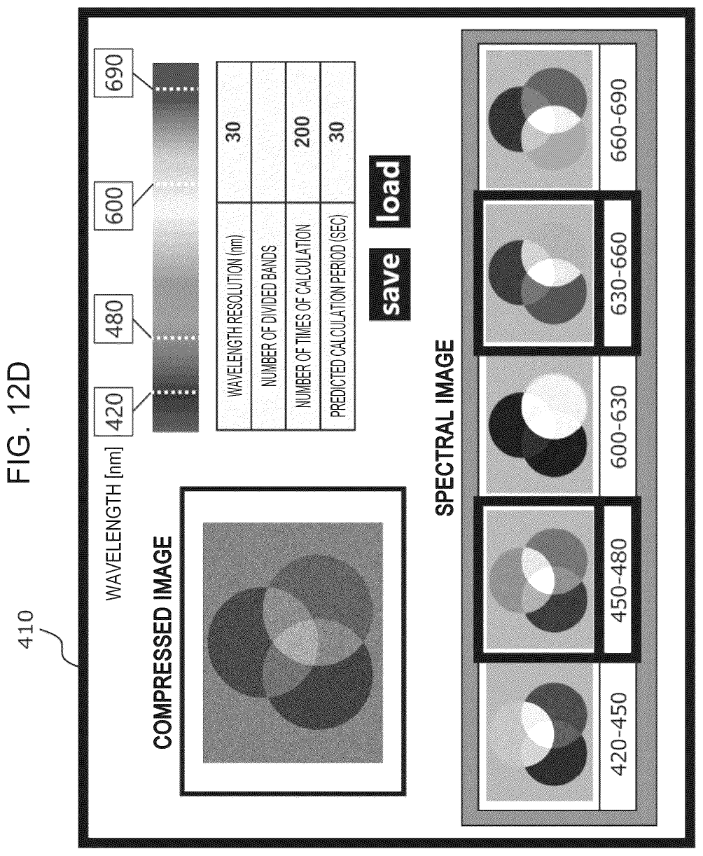

Next, an example of the display UI 410 displayed in a case where the reconstruction error is larger than the predetermined threshold value is described with reference to FIGS. 12A to 12D. FIGS. 12A to 12D illustrate first to fourth examples of the display UI 410 displayed in a case where the reconstruction error is larger than the predetermined threshold value, respectively.

In the example illustrated in FIG. 12A, a user sets the wavelength resolution to 30 nm. The target wavelength range is a wavelength range greater than or equal to 420 nm and less than or equal to 480 nm and a wavelength range greater than or equal to 600 nm and less than or equal to 690 nm. The wavelength range greater than or equal to 420 nm and less than or equal to 480 nm includes a wavelength band greater than or equal to 420 nm and less than or equal to 450 nm and a wavelength band greater than or equal to 450 nm and less than or equal to 480 nm. The wavelength range greater than or equal to 600 nm and less than or equal to 690 nm includes a wavelength band greater than or equal to 600 nm and less than or equal to 630 nm, a wavelength band greater than or equal to 630 nm and less than or equal to 660 nm, and a wavelength band greater than or equal to 660 nm and less than or equal to 690 nm. Among the five wavelength bands included in the target wavelength range, the wavelength band greater than or equal to 450 nm and less than or equal to 480 nm and the wavelength band greater than or equal to 600 nm and less than or equal to 630 nm that are adjacent to each other are not continuous.

In the example illustrated in FIG. 12A, reconstruction errors of five spectral images corresponding to the five wavelength bands are displayed as percentages on the display UI 410. The reconstruction errors may be displayed by using an index such as an MSE or a PSNR. Since the reconstruction error is estimated for each wavelength band, a wavelength band whose reconstruction error is large may be displayed in an emphasized manner. In the example illustrated in FIG. 12A, a reconstruction error exceeding 2% is displayed in an emphasized manner. Only a wavelength band whose reconstruction error is large may be displayed. Wavelength resolution set for one wavelength range may be different from wavelength resolution set for another wavelength range. For example, wavelength resolution in a certain wavelength range may be set to 10 nm, and wavelength resolution in another wavelength range may be set to 20 nm. Even in this case, a reconstruction error of each of spectral images is estimated and is displayed on the display UI 410. In this way, the signal processing circuit 250 causes the reconstruction errors to be displayed on the display 330.

In the example illustrated in FIG. 12B, in a case where an estimated reconstruction error is larger than a threshold value, error information 412 is displayed on the display UI 410. The error information 412 includes an expression notifying the user that the estimated reconstruction error is larger than the threshold value. The error information 412 may be displayed in a case where a reconstruction error of a spectral image concerning a certain wavelength band is larger than the threshold value. Alternatively, the error information 412 may be displayed in a case where an average of reconstruction errors of spectral images concerning wavelength bands is larger than the threshold value. The error information 412 may be displayed in a case where the reconstruction errors of the spectral images are given weights and a weighted average is larger than the threshold value. In this way, the signal processing circuit 250 causes a warning to be displayed on the display 330 in a case where the reconstruction error is larger than the predetermined threshold value.

In the example illustrated in FIG. 12C, a wavelength band whose reconstruction error is large is displayed in a visually noticeable manner. User's attention can be drawn by displaying the wavelength band whose reconstruction error is large in an emphasized manner instead of the numerical value or error display. In the example illustrated in FIG. 12C, a reconstruction error is displayed in an emphasized manner by hatching surrounded by a thick frame. Denser hatching indicates a larger reconstruction error. As the emphasized display, various modifications such as a sign “!” and blinking may be employed. In this way, in a case where a reconstruction error is larger than the predetermined threshold value, the signal processing circuit 250 displays a wavelength band whose reconstruction error is large in an emphasized manner.

In the example illustrated in FIG. 12D, a spectral image having a reconstruction error larger than the threshold value among the five spectral images generated on the basis of a compressed image is emphasized by a thick frame. In this way, the signal processing circuit 250 generates N spectral images on the basis of the compressed image, causes the N spectral images to be displayed on the display UI 440, and displays at least one spectral image having a reconstruction error larger than the predetermined threshold value among the N spectral images in an emphasized manner.

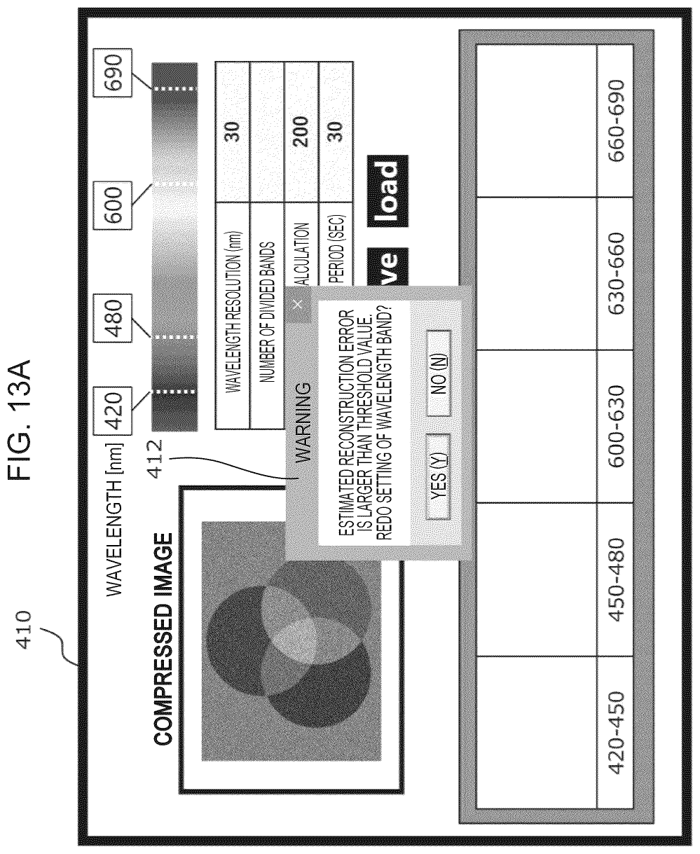

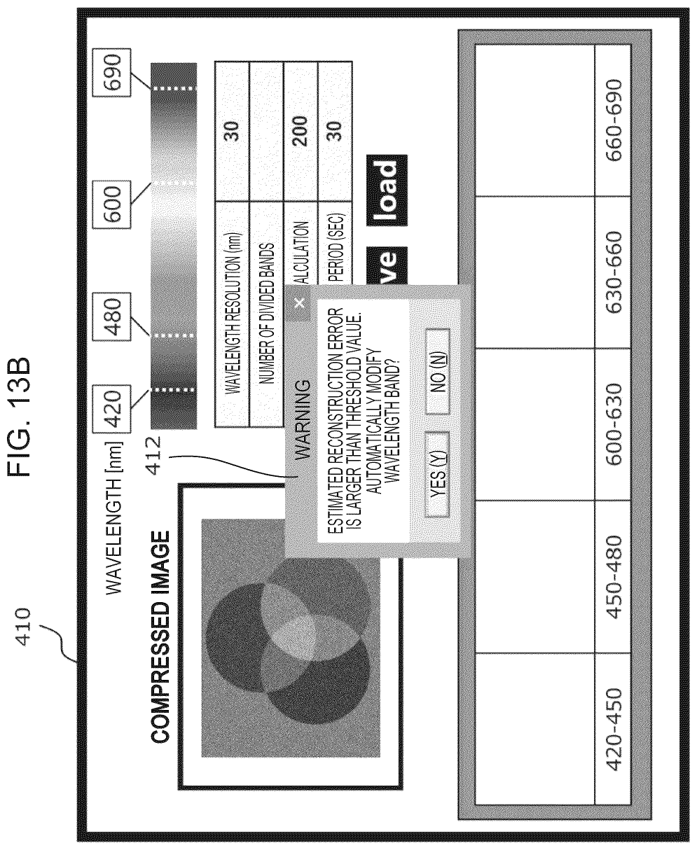

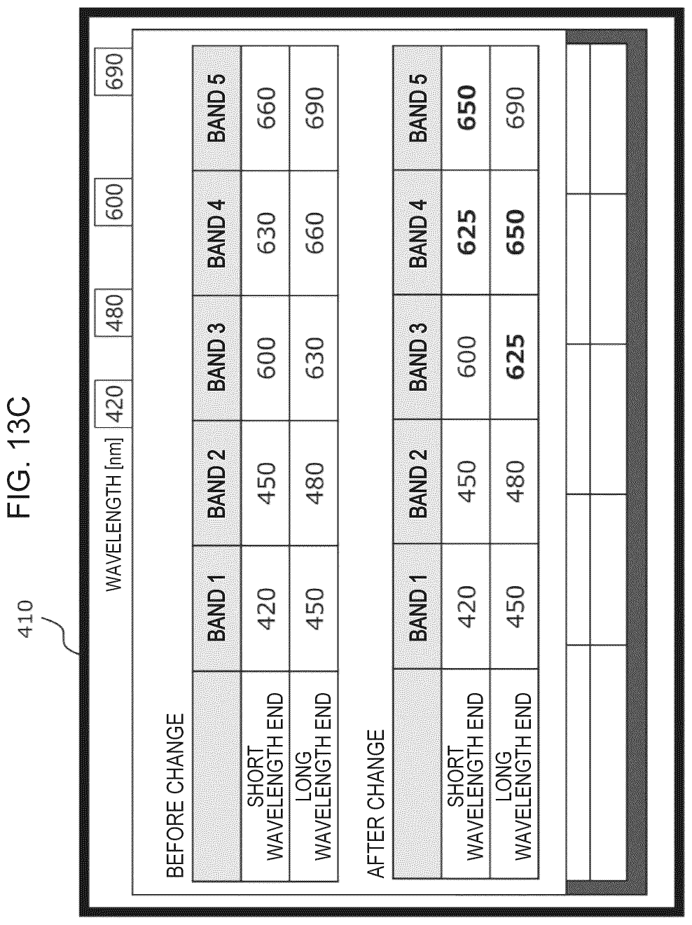

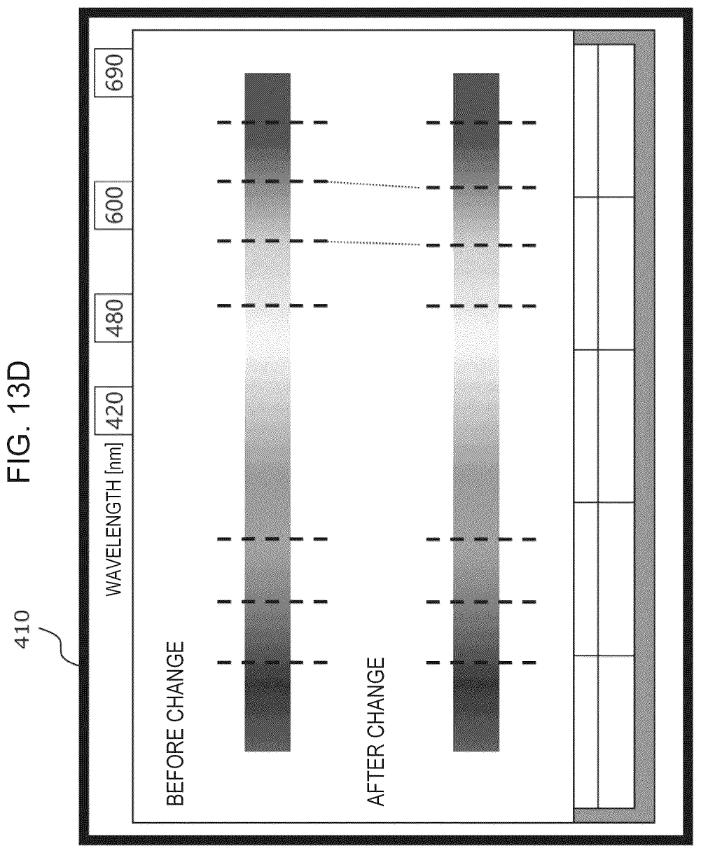

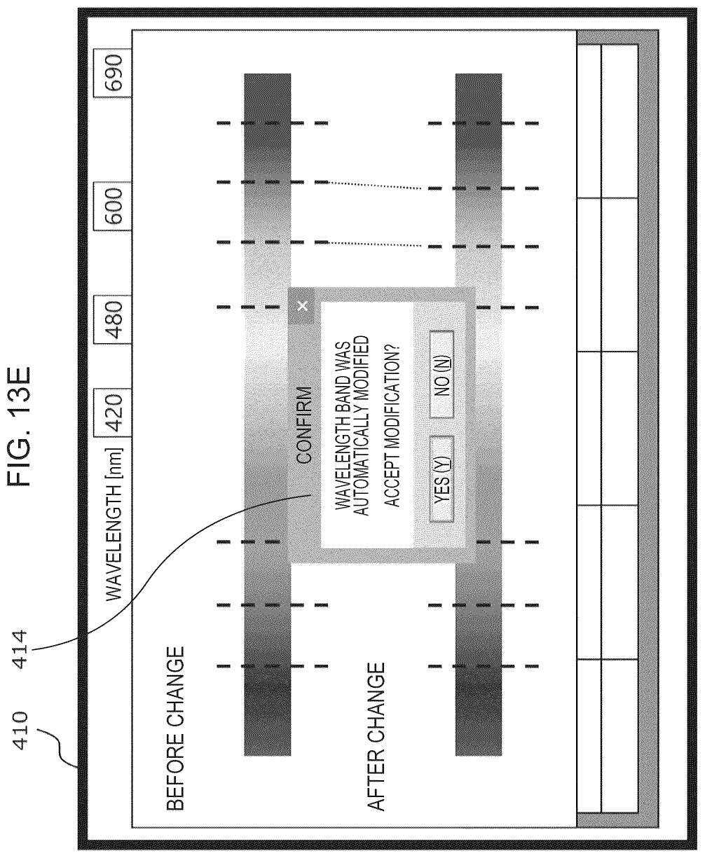

Next, an example of the display UI 410 displayed in a case where some sort of operation is recommended or performed on the basis of an estimated reconstruction error is described with reference to FIGS. 13A to 13E. FIGS. 13A to 13E illustrate first to fifth examples of the display UI 410 displayed in a case where some sort of operation is recommended or performed on the basis of an estimated reconstruction error.

In the example illustrated in FIG. 13A, in a case where the estimated reconstruction error is larger than the threshold value, the error information 412 is displayed on the display UI 410. The error information 412 includes an expression recommending modification of setting of wavelength resolution and guides the user to the input UI 400 so that the user inputs wavelength resolution again. In this way, the signal processing circuit 250 causes the input UI 400 for allowing the user to input designation information again to be displayed on the display 330.

In the example illustrated in FIG. 13B, the error information 412 is displayed as in the example illustrated in FIG. 13A. The error information 412 includes an expression for automatically modifying setting of wavelength bands so that the estimated reconstruction error becomes equal to or less than the threshold value. In this way, the signal processing circuit 250 causes a message indicative of whether or not to automatically modify the wavelength bands to be displayed on the display 330.

In the examples illustrated in FIGS. 13C and 13D, a modification result of wavelength bands is displayed by using numerical values and a drawing on the display UI 410. In the example illustrated in FIG. 13C and/or FIG. 13D, a modified portion may be displayed in an emphasized manner. In this way, the signal processing circuit 250 modifies N wavelength bands on the basis of mask data so that the reconstruction error becomes equal to or smaller than the predetermined threshold value, and causes the modified N wavelength bands to be displayed on the display 330.

In the example illustrated in FIG. 13E, confirmation information 414 is displayed on the display UI 410. The confirmation information 414 includes an expression as to whether or not to accept a modification result. The modification result may be reflected only in a case where the user accepts the modification result. In this way, the signal processing circuit 250 causes a message as to whether or not to accept the modification result to be displayed on the display 330.

Although a reconstruction error that depends on randomness of mask data in a wavelength direction has been described in the above examples, a reconstruction error that depends on randomness of mask data in a space direction actually exists. In the present embodiment, a square root of sum of squares of these two reconstruction errors may be displayed as a reconstruction error on the display UI 410. Alternatively, these two reconstruction errors may be separately displayed on the display UI 410.

The technique of the present disclosure is, for example, useful for a camera and a measurement apparatus that acquire a multiple-wavelength or high-resolution image. The technique of the present disclosure is, for example, applicable to sensing for biological, medical, and cosmetic purposes, a food foreign substance/residual pesticide inspection system, a remote sensing system, and an on-board sensing system.

What is claimed is:

1. A signal processing method executed by a computer, comprising:
acquiring designation information for designating N wavelength bands corresponding to N spectral images generated on a basis of a compressed image in which spectral information is compressed, N being an integer greater than or equal to 4; and
estimating a reconstruction error of each of the N spectral images on a basis of the designation information.

2. The signal processing method according to claim 1, wherein
the compressed image is generated by imaging using a filter array including kinds of optical filters that are different in spectral transmittance and an image sensor;
the method further comprises acquiring mask data reflecting spatial distributions of the spectral transmittance of the filter array concerning the N wavelength bands; and
the estimating the reconstruction error includes estimating the reconstruction error on a basis of the designation information and the mask data.

3. The signal processing method according to claim 2, wherein
the N wavelength bands include an i-th wavelength band and a j-th wavelength band; and
the estimating the reconstruction error includes:
extracting, from the mask data, i-th mask data reflecting a spatial distribution of transmittance of the filter array corresponding to the i-th wavelength band and j-th mask data reflecting a spatial distribution of transmittance of the filter array corresponding to the j-th wavelength band among the N wavelength bands on a basis of the designation information, and
estimating the reconstruction error on a basis of a correlation coefficient between the i-th mask data and the j-th mask data.

4. The signal processing method according to claim 2, further comprising displaying a GUI for allowing a user to input the designation information on a display connected to the computer.

5. The signal processing method according to claim 4, further comprising displaying a warning on the display in a case where the reconstruction error is larger than a predetermined threshold value.

6. The signal processing method according to claim 5, further comprising displaying a GUI for allowing the user to input the designation information again on the display.

7. The signal processing method according to claim 5, further comprising:
changing the N wavelength bands on a basis of the mask data so that the reconstruction error becomes equal to or smaller than the predetermined threshold value; and
displaying the changed N wavelength bands on the display.

8. The signal processing method according to claim 4, further comprising:
generating the N spectral images on a basis of the compressed image;
displaying the N spectral images on the display; and
displaying at least one spectral image having a reconstruction error larger than a predetermined threshold value among the N spectral images in an emphasized manner.

9. The signal processing method according to claim 4, further comprising displaying the reconstruction error on the display.

10. The signal processing method according to claim 1, wherein
the N wavelength bands include two adjacent wavelength bands that are not continuous.

11. The signal processing method according to claim 1, further comprising acquiring data indicative of a relationship between the wavelength bands and the reconstruction error,
wherein the estimating the reconstruction error includes estimating the reconstruction error of each of the N spectral images on a basis of the data.

12. A non-volatile computer-readable recording medium storing a program causing a computer to perform processing comprising:
acquiring designation information for designating N wavelength bands corresponding to N spectral images generated on a basis of a compressed image in which spectral information is compressed, N being an integer greater than or equal to 4; and
estimating a reconstruction error of each of the N spectral images on a basis of the designation information.

13. A system comprising a signal processing circuit,
wherein the signal processing circuit acquires designation information for designating N wavelength bands corresponding to N spectral images generated on a basis of a compressed image in which spectral information is compressed, N being an integer greater than or equal to 4, and estimates a reconstruction error of each of the N spectral images on a basis of the designation information.
